(19) United States
(12) Patent Application Publication
(10) Pub. No.: US 2014/0173461 A1
(43) Pub. Date: Jun. 19, 2014

(54) Electronic Community Board Creation And Management System

(71) Applicant: Satyajeet Arvind Shahade, Robbinsville, NJ (US)

(72) Inventor: Satyajeet Arvind Shahade, Robbinsville, NJ (US)

(21) Appl. No.: 14/032,421

(22) Filed: Sep. 20, 2013

Related U.S. Application Data
(60) Provisional application No. 61/703,927, filed on Sep. 21, 2012.

(51) Int. Cl. H04L 29/06; G06F 3/0484

(52) U.S. Cl. CPC H04L 65/403; G06F 3/0484
USPC 715/753

(57) ABSTRACT

A computer implemented method and system for simultaneously engaging multiple electronic community boards associated with multiple communities is provided. An electronic community board management platform (ECBMP) receives user information and board information via a graphical user interface, creates one or more electronic community boards associated with one or more communities using the user information and the board information, and generates a unique collective electronic community board for a user using the created electronic community boards. The ECBMP creates and adjusts characteristics of one or more interactive electronic posts in one or more media formats based on media inputs from an electronic device. The ECBMP selectively displays the interactive electronic posts on the created electronic community boards based on display criteria including user location, device location, community location, etc. The ECBMP manages actions, payment transactions, etc., triggered by user inputs from the electronic device on the unique collective electronic community board.

### CROSS REFERENCE TO RELATED APPLICATIONS

This application claims the benefit of provisional patent application No. 61/703,927 titled “Electronic Community Board Creation And Management System”, filed in the United States Patent and Trademark Office on Sep. 21, 2012.

The specification of the above referenced patent application is incorporated herein by reference in its entirety.

### BACKGROUND

The influence of a widespread information infrastructure such as the internet reaches not only technical fields of computer communications but also multiple communities throughout society due to an increase in the use of online tools to accomplish, for example, electronic commerce, information acquisition, community operations, entertainment activities, etc. Since the advent of the internet, the concept of a community has less geographical limitations, as users can gather virtually in an online community and share common interests regardless of their physical location. Prior to the internet, virtual communities, for example, social or academic organizations were far more limited by constraints of available communication and transportation technologies.

Websites developed for common interest communities typically include content directed towards events or other information of interest to that community. Such websites are mostly in the form of chat rooms, electronic community boards, blogs, or websites directed towards one type of activity. An electronic community board allows a user to collaborate with other users who share common interests, professions, beliefs, and/or other attributes and perform functions such as reading news and bulletins, uploading and downloading software and data, exchanging messages through electronic mail (email), public message boards such as bulletin boards or classified listing boards, etc., online chatting, etc. Some electronic community boards also offer online games that allow users to compete with each other. The popularity of the electronic community board depends in part on the ease with which the user can access and locate content within the electronic community board.

As the popularity of electronic community boards has increased, the number of networks to update and track these electronic community boards has also increased. Different users make use of different private and public electronic community boards, and information is scattered among many services and applications. As these electronic community boards rarely interoperate, each electronic community board is typically only aware of its own data and cannot benefit from other electronic community boards. Most of these electronic community boards are scattered, isolated, localized, and are non-scalable, and there is no centralized channel or mechanism to communicate across these different electronic community boards in a collective or an embedded manner. Hence, there is a need for a platform that integrates multiple electronic community boards into a single collective service, embeds and provides access to electronic community boards across various community websites and platforms, and organizes or simplifies the process of sharing information within different communities.

Although some electronic community boards allow users to create electronic posts for promoting various services, these electronic community boards do not allow a user to create and customize interactive electronic posts using various media. Moreover, conventional electronic community boards do not allow a user to upload or use external electronic posts in different formats from multiple different sources for sharing or displaying the electronic posts on multiple electronic community boards and/or on multiple different devices. Furthermore, these electronic community boards do not provide options to adjust characteristics of an electronic post based on user preferences to display an enhanced version of the electronic post that is more appealing and that would improve viewership on the electronic community boards. Furthermore, conventional electronic community boards do not allow a selective display of electronic posts, for example, based on a location of a user, a location of a community to which a user belongs, the location defined in the content of the electronic post, the location of a display device configured to display the electronic community boards and/or the electronic posts, etc. Conventional electronic community boards also do not allow users to search for electronic posts or other electronic community boards based on location. Hence, there is a need for a platform that allows users to create interactive electronic posts, uploads external electronic posts in multiple formats, allows adjustments of the interactive electronic posts, and provides location based search options. Moreover, there is a need for targeting electronic posts for engagement within one or more communities.

Conventional electronic community boards are also not configured to receive user inputs and gestures of different types from constantly evolving electronic devices having enhanced capabilities to trigger actions, payment transactions, etc., on the electronic community boards.

Hence, there is a long felt but unresolved need for a computer implemented method and system that enables simultaneous engagement of multiple private electronic community boards and public electronic community boards associated with multiple communities. Moreover, there is a need for an electronic community board management platform that integrates multiple electronic community boards into a unique collective electronic community board, embeds and provides access to electronic community boards across various community websites and platforms, enables creation and enhancement of interactive electronic posts, allows electronic post uploads in different formats from multiple different sources, selectively displays electronic posts based on multiple criteria, for example, location, provides location based search options, and targets electronic posts for engagement within one or more communities. Furthermore, there is a need for an electronic community board management platform that communicates with electronic devices of different types and receives user inputs and gestures of different types to trigger actions, payment transactions, etc., on the electronic community boards.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein addresses the above stated need for simultaneously engaging multiple private electronic community boards and public electronic community boards, collectively referred to as “electronic community boards”, associated with multiple communities. The computer implemented method and system disclosed herein engages or performs multiple actions associated with the electronic community boards, for example, creating, uploading, displaying, sharing, searching, filtering, and managing flyers or electronic posts. The computer implemented method and system disclosed herein integrates multiple electronic community boards into a unique collective electronic community board, embeds and provides access to electronic community boards across various community websites and platforms, enables creation and enhancement of interactive electronic posts, allows electronic post uploads in different formats from multiple different sources, selectively displays electronic posts based on multiple criteria, for example, location, provides location based search options, and targets electronic posts for engagement within one or more communities. Furthermore, the computer implemented method and system disclosed herein communicates with electronic devices of different types and receives user inputs and gestures of different types to trigger actions, payment transactions, etc., on the electronic community boards.

The computer implemented method and system disclosed herein provides an electronic community board management platform comprising at least one processor configured to enable simultaneous engagement of electronic community boards associated with multiple communities. The electronic community board management platform is accessible by multiple electronic devices via a network, for example, the internet. As used herein, the term “electronic device” refers to a user device, for example, a smart phone, a laptop, a tablet computer, a personal digital assistant, a personal computer, a mobile phone, a network enabled computing device, an interactive network enabled communication device, an image capture device, etc., or a display device, for example, a display screen, a networked display board, a web browser, a mobile browser, a graphical user interface (GUI), etc., or a device with motion sensors and other sensors, etc., capable of accepting multiple different types of user inputs from a user and detecting multiple gestures of the user. Also, as used herein, the term “user inputs” refers to inputs provided by a user using the electronic device to execute multiple operations on the electronic community board management platform. The user inputs comprise, for example, tactile inputs provided using a touch of a finger or another body part or a stylus, textual inputs provided using an input device such as a keyboard, computer mouse clicks, pointing device inputs, voice inputs, etc. Also, as used herein, the term “gesture” refers to a user action or an actuation by a user performed manually, for example, by use of a finger, a thumb, a wave of a hand or another body part, etc., on a graphical user interface (GUI) of the electronic device, or by using an input device, for example, a physical button, a computer mouse, a pointing device, a light pen, a touch pad, a touch sensitive display device, a track ball, a pointing stick, any device capable of sensing a tactile input, etc. The gestures comprise, for example, hand gestures such as wave gestures, computer mouse gestures performed with a computer mouse or a stylus, etc.

The electronic community board management platform receives user information and board information via a graphical user interface (GUI) provided by the electronic community board management platform. The electronic community board management platform creates one or more electronic community boards associated with one or more communities using the received user information and board information. In an embodiment, the electronic community board management platform controls access to the created electronic community boards based on the received board information. The electronic community board management platform transmits electronic invitations to one or more users via the network for enabling creation of one or more electronic community boards and/or joining one or more of the created electronic community boards. In an embodiment, the electronic community board management platform embeds the created electronic community boards on one or more websites hosted by one or more communities. The electronic community board management platform generates a unique collective electronic community board for a user associated with one or more communities using the created electronic community boards.

The electronic community board management platform creates one or more interactive electronic posts in one or more media formats based on media inputs received from an electronic device, for example, a user device. The media inputs for creating the interactive electronic posts comprise, for example, one or more of themes, layouts, and media content. The media content comprises, for example, one or more of textual content, image content, audio content, video content, audiovisual content, multimedia content, digital content, widgets, web objects such as buttons, graphical icons, etc., and any combination thereof. The interactive electronic posts are configured in one or more of multiple media formats, for example, a text format, an image format, an audio format, a video format, an audiovisual format, a multimedia format, etc., and any combination thereof.

In an embodiment, the electronic community board management platform allows a user to upload external electronic posts in multiple formats, for example, a portable document format (PDF) from one or more of multiple sources. The sources comprise, for example, user devices, external websites, third party applications, third party services and websites, data sources that transfer data through files in multiple formats such as a JavaScript object notation (JSON) format, an extensible markup language (XML) format, etc. In another embodiment, the electronic community board management platform integrates multiple document editors, for example, Microsoft Word™ of Microsoft Corporation, Google Docs of Google, Inc., etc. The electronic community board management platform receives one or more electronic posts from the integrated document editors, for example, via application programming interfaces (APIs), and displays and/or shares the received interactive electronic posts on the created electronic community boards.

In an embodiment, the electronic community board management platform provides post enhancing options for adjusting characteristics, for example, size, resolution, color, aesthetics, etc., of each of the created interactive electronic posts, for example, prior to displaying and/or sharing the created interactive electronic posts on the created electronic community boards. The electronic community board management platform also allows the user to adjust the characteristics of external electronic posts after uploading the external electronic posts on the created electronic community boards. In this embodiment, the electronic community board management platform automatically calculates a cost associated with the adjustment of the characteristics, for example, the size of each of the created interactive electronic posts or the size of the uploaded external electronic posts and executes a payment transaction based on the calculated cost.

The electronic community board management platform selectively displays the created interactive electronic posts on the created electronic community boards based on display criteria. The display criteria comprise, for example, one or more of community type, privacy settings, user preferences, content of the created interactive electronic posts, type of the created electronic community boards, a location of the user associated with one or more communities, a location of each community, a location defined in each of the created interactive electronic posts, a location of the electronic device configured to display the electronic community boards and/or the interactive electronic posts, etc. The electronic community board management platform also selectively displays the uploaded external electronic posts on the created electronic community boards. In an embodiment, the electronic community board management platform requests approval from the user for simultaneously displaying the created interactive electronic posts on the created electronic community boards.

In an embodiment, the electronic community board management platform categorizes and manages the created interactive electronic posts on the created electronic community boards. In another embodiment, the electronic community board management platform filters the created interactive electronic posts displayed on the created electronic community boards based on filter criteria, for example, a type of the interactive electronic post, the type of the electronic community board, location, etc. In an embodiment, the electronic community board management platform targets the created interactive electronic posts to one or more communities based on targeting criteria. The targeting criteria comprise, for example, one or more of type of communities, content of the interactive electronic posts, type of the electronic community boards, user profiles, a location of the user associated with one or more communities or a location selected by the user, previously stored location preferences, a location of each of the communities, a location defined in each of the created interactive electronic posts, etc.

The electronic community board management platform provides a search engine configured to allow the user to search for the created electronic community boards and/or the created interactive electronic posts on the created electronic community boards simultaneously based on search criteria. The search criteria comprise, for example, one or more of a location of each of the communities, a location defined in each of the created one or more interactive electronic posts, a location of the electronic device configured to display the electronic community boards and/or the interactive electronic posts, etc. In an embodiment, the electronic community board management platform shares the created interactive electronic posts with one or more users associated with one or more communities based on sharing options provided by the electronic community board management platform. The sharing options comprise, for example, one or more of privately sharing the created interactive electronic posts on the created electronic community boards, sharing the created interactive electronic posts via electronic mail (email), posting the created interactive electronic posts on one or more social networking platforms, etc. In an embodiment, the electronic community board management platform integrates multiple social networking platforms within the electronic community board management platform via the network for facilitating creation of the electronic community boards and creation of the interactive electronic posts, and sharing of the created interactive electronic posts via the network.

In an embodiment, the electronic community board management platform displays the generated unique collective electronic community board and the created interactive electronic posts on multiple electronic devices, for example, electronic display boards, browsers, third party platform applications, etc. The electronic community board management platform is configured to communicate with these electronic devices via a network. The electronic community board management platform receives user inputs and gestures of multiple different types from these electronic devices. The electronic community board management platform manages actions triggered by user inputs received from the user device or via another electronic device on the generated unique collective electronic community board. In an embodiment, the electronic community board management platform generates and transmits notifications associated with the actions triggered by the user inputs received from the user device or another electronic device on the generated unique collective electronic community board.

In an embodiment, the electronic community board management platform provides one or more incentives to a user, for example, based on the number of created interactive electronic posts shared by the user and the number of created electronic community boards engaged by the user. As used herein, the term “incentives” refers to online and/or offline items of value, for example, gift cards, gift certificates, loyalty cards, reward cards, virtual points, virtual currencies, commissions, access to rich media content, etc., that can be allocated and converted into real or virtual points, currency, etc.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 exemplarily illustrates a computer implemented method for simultaneously engaging multiple electronic community boards associated with multiple communities.

FIGS. 2A-2C exemplarily illustrate a flowchart comprising the steps performed by an electronic community board management platform for creating an electronic community board.

FIGS. 3A-3B exemplarily illustrate a flowchart comprising the steps performed by the electronic community board management platform for enabling a user to join an electronic community board.

FIGS. 4A-4B exemplarily illustrate a flowchart comprising the steps performed by the electronic community board management platform for creating interactive electronic posts for selective display on multiple electronic community boards.

FIG. 5 illustrates a computer implemented system for simultaneously engaging multiple electronic community boards associated with multiple communities.

FIG. 6 exemplarily illustrates a data model outlining key data relationships among various elements of the electronic community board management platform.

FIG. 7 exemplarily illustrates the architecture of a computer system employed by the electronic community board management platform for simultaneously engaging multiple electronic community boards associated with multiple communities.

FIG. 8 exemplarily illustrates a screenshot of a graphical user interface provided by the electronic community board management platform.

FIG. 9 exemplarily illustrates a screenshot of an electronic community board associated with a community.

FIG. 10 exemplarily illustrates a screenshot of a graphical user interface provided by the electronic community board management platform, displaying interactive electronic posts across different electronic community boards simultaneously.

FIG. 11A exemplarily illustrates a screenshot of a graphical user interface provided by the electronic community board management platform, showing an electronic community board in a graphical format with multiple community board filters.

FIG. 11B exemplarily illustrates a screenshot of a graphical user interface provided by the electronic community board management platform, showing options for creating an interactive electronic post on a graphics based electronic community board.

FIG. 11C exemplarily illustrates a screenshot of a graphical user interface provided by the electronic community board management platform, showing multiple multimedia posting types for viewing interactive electronic posts.

FIG. 11D exemplarily illustrates a screenshot of a graphical user interface provided by the electronic community board management platform, showing location based electronic community boards.

FIGS. 12A-12C exemplarily illustrate screenshots of a graphical user interface provided by the electronic community board management platform for creating an interactive electronic post.

FIGS. 13A-13C exemplarily illustrate screenshots of a graphical user interface provided by the electronic community board management platform for adjusting characteristics of an interactive electronic post.

FIGS. 14A-14D exemplarily illustrate screenshots of an electronic community board embedded in a website hosted by a community.

FIG. 15 exemplarily illustrates display of an electronic community board on an electronic device that communicates with the electronic community board management platform in a community environment.

### DETAILED DESCRIPTION OF THE INVENTION

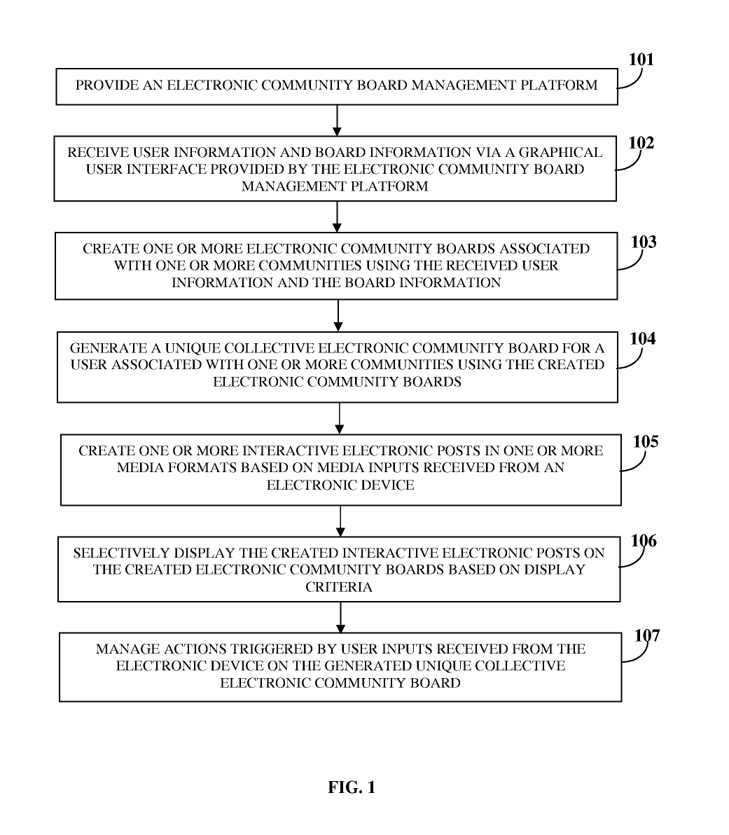

FIG. 1 exemplarily illustrates a computer implemented method for simultaneously engaging multiple electronic community boards associated with multiple communities. As used herein, the term “community” refers to a social unit or a social network of users that share common values, activities, interests, preferences, resources, etc., and interact to pursue mutual interests and goals. The communities comprise, for example, schools, colleges, universities, companies, workplaces, townships, geographical areas, organizations of faith, sports groups, a group or a congregation of people, businesses, etc. The computer implemented method disclosed herein engages or performs multiple actions associated with multiple electronic community boards, for example, creating, uploading, displaying, sharing, searching, filtering, and managing flyers or electronic posts. The computer implemented method disclosed herein provides 101 an electronic community board management platform comprising at least one processor configured to enable simultaneous engagement of private electronic community boards and public electronic community boards, herein collectively referred to as “electronic community boards”, associated with multiple communities. A public electronic community board allows users to join a community at their discretion. The public electronic community boards may or may not be moderated. A private electronic community board allows users to join a community by using a board code or with administrator permission. For example, in order to join authenticated private electronic community boards, users such as board members are required to produce an official electronic mail (email) identifier (ID) or address for authentication. In another example, the electronic community board management platform performs a lightweight directory access protocol (LDAP) type of authentication to authenticate users prior to allowing them to join the private electronic community boards. In an embodiment, the electronic community board management platform is implemented as a website or a web-based platform hosted on a server or a network of servers. In another embodiment, the electronic community board management platform is implemented in a cloud computing environment. As used herein, the term “cloud computing environment” refers to a processing environment comprising configurable computing physical and logical resources, for example, networks, servers, storage, applications, services, etc., and data distributed over a network, for example, the internet. The cloud computing environment provides on-demand network access to a shared pool of the configurable computing physical and logical resources. The electronic community board management platform is, for example, a cloud computing based platform implemented as a service for simultaneously engaging multiple electronic community boards associated with multiple communities.

The electronic community board management platform is accessible by multiple electronic devices via a network. As used herein the term “electronic device” refers to a user device, or a display device, or a device with motion sensors and other sensors capable of accepting multiple different types of user inputs from a user and detecting gestures of the user. Also, as used herein, the term “user inputs” refers to inputs provided by a user using the electronic device to execute multiple operations on the electronic community board management platform. The user inputs comprise, for example, tactile inputs provided using a touch of a finger or another body part or a stylus, textual inputs provided using an input device such as a keyboard, computer mouse clicks, pointing device inputs, voice inputs, etc. Also, as used herein, the term “gesture” refers to a user action or an actuation by a user performed manually, for example, by use of a finger, a thumb, a wave of a hand or another body part, etc., on a graphical user interface (GUI) of the electronic device, or by using an input device, for example, a physical button, a computer mouse, a pointing device, a light pen, a touch pad, a touch sensitive display device, a track ball, a pointing stick, any device capable of sensing a tactile input, etc. The gestures comprise, for example, hand gestures such as wave gestures, computer mouse gestures performed with a computer mouse or a stylus, etc.

In an embodiment, the electronic device is a user device, for example, a personal computer, a tablet computing device, a mobile computer, a mobile phone, a smart phone, a portable computing device, a laptop, a personal digital assistant, a touch centric device, a workstation, a client device, a portable electronic device, a network enabled computing device, an interactive network enabled communication device, a device with motion sensors and other sensors or data readers such as credit card readers, any other suitable computing equipment, and combinations of multiple pieces of computing equipment, etc. In another embodiment, the electronic device is an interface or a display device, for example, a display screen, an electronic display board, a billboard, a digitized bulletin board, a monitor, a liquid crystal display screen, a plasma display screen, a device with a card reader such as a credit card reader, a debit card reader, etc., a fiber optic display screen, a web browser, a mobile browser, a graphical user interface, etc. The electronic community board management platform is accessible via a web browser, a mobile browser, widgets, plug-ins, applications such as desktop applications, application program interfaces (APIs), mobile applications, tablet applications, personal computer (PC)/media access control (MAC) applications, third party applications such as an application on Facebook® of Facebook, Inc., web site platform applications or cloud based web development platforms such as wix.com, 1and1.com of 1&1 Internet AG Corporation, etc.

The network for accessing and communicating with the electronic community board management platform is, for example, the internet, an intranet, a wired network, a wireless network, a network that implements Wi-Fi® of the Wireless Ethernet Compatibility Alliance, Inc., an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, a public telephone network, etc., a local area network, a wide area network, an internet connection network, an infrared communication network, etc., or a network formed from any combination of these networks.

The electronic community board management platform is configured as an online bulletin board platform that allows posting and viewing of interactive electronic posts, for example, flyers herein referred to as “hoots”, messages, announcements, etc. The electronic community board management platform receives 102 user information and board information from the user via a graphical user interface (GUI) provided by the electronic community board management platform. The user information comprises, for example, the user's identification information such as a name, contact details, an email ID or address, user preferences, login information, payment information, etc. The board information comprises, for example, type of electronic community board that the user wishes to create or join, type of community associated with the electronic community board, board details, board privacy settings, etc.

The electronic community board management platform creates 103 one or more electronic community boards associated with one or more communities using the received user information and the board information. For example, the electronic community board management platform receives user information and board information from users such as individuals, officers, managers, employees, etc., to create an electronic community board for any type of community, for example, a school, a college, a university, a company, a workplace, a township, a geographical area, an organization of faith, a sports group, a group or congregation of people, businesses, other entities, etc. The electronic community board management platform enables a user to create, access, post messages to, search, view, filter, and sort the created electronic community boards and/or the board information on one or more of the created electronic community boards.

In an embodiment, the electronic community board management platform controls access, for example, public access, private access, selective access, etc., to the created electronic community boards based on the board information received from the user. The electronic community boards can therefore be made public, private, or authenticated. The electronic community board management platform allows creation of public electronic community boards, private electronic community boards which are based on a security code or moderator approval, and authenticated electronic community boards that are authenticated by validating a prospective member's official email address domain. If the user enters an email address, the electronic community board management platform checks whether an electronic community board associated with that email address domain already exists. If an electronic community board associated with that email address domain already exists, the electronic community board management platform sends an invitation to the user to join the electronic community board. If an electronic community board associated with that email address domain does not exist, the electronic community board management platform transmits an invitation to the user to create that electronic community board.

The electronic community board management platform transmits electronic invitations to one or more users via the network for enabling creation of one or more electronic community boards and/or joining one or more of the created electronic community boards. Based on the type of invitation, the electronic community board management platform guides the user to either create or join the electronic community board that is associated, for example, with the email domain of the user. The electronic community board management platform prompts the user to invite other members to join the electronic community board. If the user originally wanted to create an electronic community board without an email domain authentication, the electronic community board management platform allows the user to enter board information comprising, for example, a unique board code on the GUI for distribution to prospective members. If a payment is required for creating a private electronic community board, the electronic community board management platform prompts the user to make payments before the private electronic community board is created for the user. The user finalizes and submits an electronic community board application which may or may not be approved by an administrator of the electronic community board management platform. In an embodiment, the electronic community board management platform employs automatic approvals of the electronic community board applications. When the electronic community board application of the user is approved, the user can invite other users to join the electronic community board via the GUI. The electronic community board management platform allows users to join multiple electronic community boards either when a user becomes a member of the electronic community board management platform or during various usage sessions.

The electronic community board management platform generates 104 a unique collective electronic community board for a user associated with one or more communities using the created electronic community boards. The user can view multiple electronic community boards with which the user is associated, in the unique collective electronic community board displayed on the GUI provided by the electronic community board management platform. The generated unique collective electronic community board collectively displays interactive electronic posts created by the users in one or more communities with which the user is associated. Each user can therefore view the interactive electronic posts created by other users on multiple electronic community boards in a single collective electronic community board that is unique to the user. The electronic community board management platform enables a user to search, filter, and sort interactive electronic posts across multiple electronic community boards of which the user is a member.

The electronic community board management platform creates 105 one or more interactive electronic posts online in one or more media formats based on media inputs received from the user device of each user associated with one or more communities or from another electronic device. The interactive electronic posts are configured in one or more of multiple media formats, for example, a text format, an image format, an audio format, a video format, an audiovisual format, a multimedia format, etc., and any combination thereof. The media inputs for creating one or more interactive electronic posts comprise, for example, one or more of themes, layouts, and media content. The media content comprises, for example, one or more of textual content, image content, audio content, video content, audiovisual content, multimedia content, digital content, widgets, web objects such as buttons, graphical icons, etc., and any combination thereof. In another embodiment, the electronic community board management platform integrates multiple document editors, for example, Microsoft Word™ of Microsoft Corporation, Google Docs of Google, Inc., etc. The electronic community board management platform receives one or more electronic posts from the integrated document editors or web services, for example, via application programming interfaces (APIs) and shares the received electronic posts on the created electronic community boards.

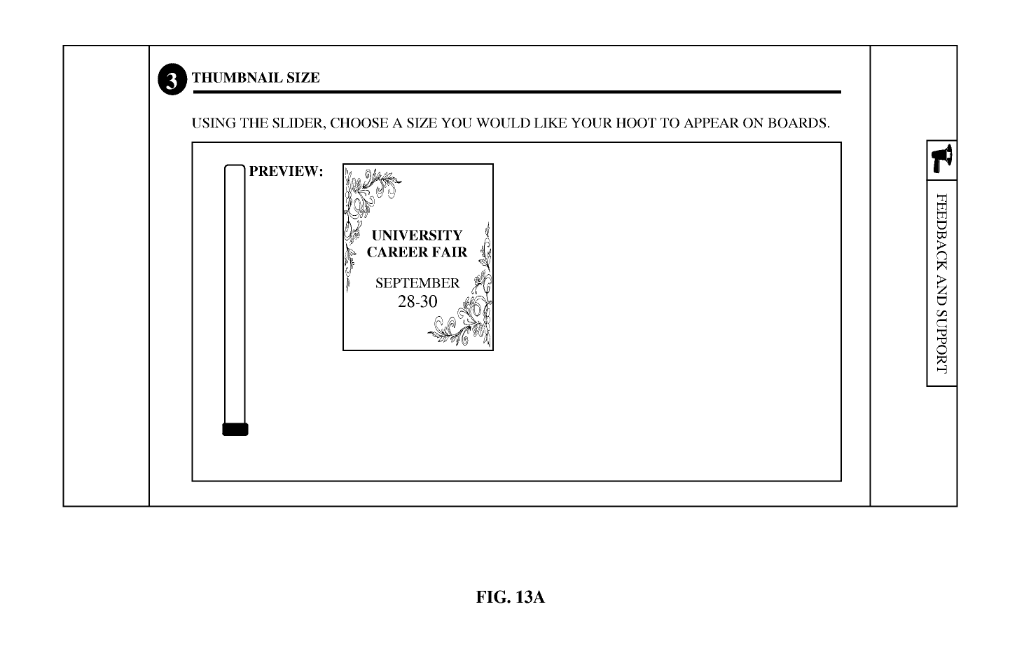

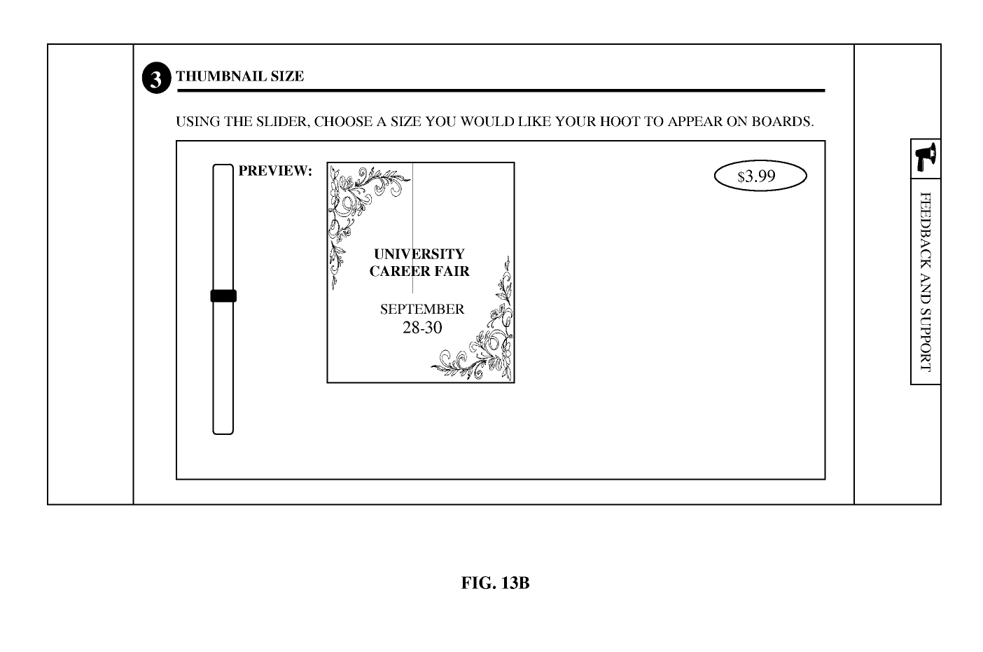

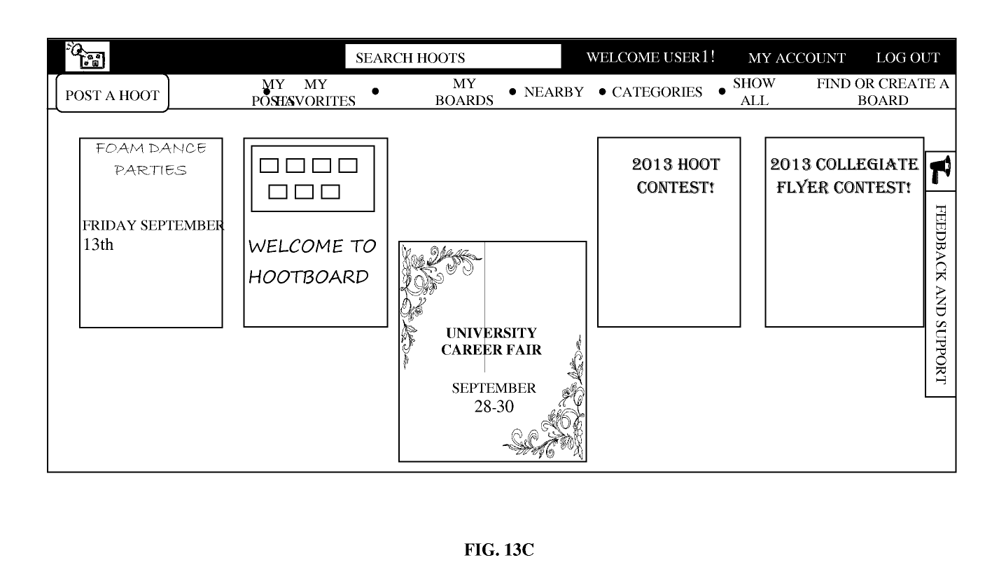

In an embodiment, the electronic community board management platform allows a user to upload external electronic posts in multiple formats from one or more of multiple sources. The sources comprise, for example, user devices, external websites, third party applications, third party services and websites, data sources that transfer data through files in multiple formats such as a JavaScript object notation (JSON) format, an extensible markup language (XML) format, etc. In an example, the electronic community board management platform uploads electronic posts, for example, in a portable document format (PDF) from a user device. In another example, the electronic community board management platform uploads posts made through third party services via application programming interfaces (APIs). In an embodiment, the electronic community board management platform provides post enhancing options for adjusting characteristics of each of the interactive electronic posts and charges the user for the adjustments as disclosed in the detailed description of FIGS. 13A-13C. As used herein, the term “characteristics” refers to attributes, for example, size, resolution, color, aesthetics, etc., of an electronic post that can be configured to create an enhanced version of the electronic post that is more appealing and that would improve viewership on the electronic community boards. In an embodiment, the electronic community board management platform embeds one or more of the created interactive electronic posts on other websites, display channels, mobile applications, third party applications, tablet applications, third party platforms, social networking platforms, website platforms, etc.

The electronic community board management platform selectively displays 106 the created interactive electronic posts on the created electronic community boards based on display criteria. The display criteria comprise, for example, one or more of community type, privacy settings, user preferences, content of the created interactive electronic posts, type of the electronic community boards, a location of the user associated with one or more communities, a location of each of the communities, a location defined in each of the created interactive electronic posts, a location of an electronic device such as a display device configured to display the electronic community boards and/or the interactive electronic posts. The geographic or location based criteria comprises, for example, the detected location of the user or the location selected by the user, previously stored location preferences, etc. The electronic community board management platform therefore selectively displays the electronic community boards, the created interactive electronic posts, the uploaded external electronic posts, the electronic posts received from document editors or web services, etc., on the created electronic community boards based on community memberships, geographic or location interest or presence, etc. In an example, if the content of an interactive electronic post is related to a job opening in a company, the electronic community board management platform displays the interactive electronic post on the electronic community boards associated with companies, workplaces, universities, etc. In another example, if a university has introduced a new course in metallurgical engineering and wants to advertise the course to students all over the country, the administrator of the university can create an electronic post advertising the new curriculum on the electronic community board management platform. The electronic community board management platform then displays the created electronic post on student related electronic community boards.

In another example, if multiple interactive electronic posts comprising information on a particular sports team are created, the electronic community board management platform displays these interactive electronic posts on an electronic community board associated with the sports team to users who are part of a community that supports that sports team. In another example, if an interactive electronic post is configured with a private status, the electronic community board management platform displays the private interactive electronic post on an electronic community board accessible to only authorized users who belong to the same community as the user who created the private interactive electronic post. In another example, the electronic community board management platform displays public interactive electronic posts on all electronic community boards and websites that a user accesses. In another example, the electronic community board management platform displays interactive electronic posts related to a user's location on the electronic community boards of the user. In another example, the electronic community board management platform selects interactive electronic posts associated with a particular geographical location and transmits the selected interactive electronic posts to a display device positioned at that particular geographical location via a network. A user in the vicinity of the display device may then browse through the location based interactive electronic posts displayed on the display device.

In an embodiment, the electronic community board management platform requests approval from the users for simultaneously displaying the interactive electronic posts created by the users on the created electronic community boards. That is, the electronic community board management platform requests permission from the users to display their created interactive electronic posts on multiple electronic community boards. The created electronic community boards and the interactive electronic posts are community targeted or geographically targeted. The electronic community board management platform displays the created interactive electronic posts, the created electronic community boards, and the generated unique collective electronic community board based on community memberships or geographic and/or location interest or presence of the users.

In another embodiment, the electronic community board management platform displays the generated unique collective electronic community board and the created interactive electronic posts on multiple electronic devices, for example, electronic display boards, display devices, etc. The electronic community board management platform communicates with these electronic devices via a network, for example, the internet and receives user inputs and gestures of multiple different types from the electronic devices, for example, for triggering actions, creating interactive electronic posts, browsing the created electronic community boards, executing payment transactions, etc. In an example, wave motion sensor based networked display boards can be outfitted in lobbies of buildings and other public places where users can interact with a digital community board. The user may provide wave motion inputs on the display screen to browse the electronic community board. The electronic community board management platform communicates with these display boards via a network. The electronic community board management platform receives a user's hand gestures or wave motion inputs provided to the display boards via the network.

In an embodiment, the GUI provided by the electronic community board management platform is adaptable to multiple electronic devices. The electronic community board management platform allows automatic adaptation of the GUI on a wide variety of electronic devices or display devices, thereby ensuring that the user of the electronic community board management platform is supplied with a GUI that is configured to be viewable and operable on a wide variety of connected display devices. The electronic community board management platform automatically adjusts the display resolution of the unique collective electronic community board and/or the individually created electronic community boards based on the screen size of the electronic devices.

In another embodiment, the electronic community board management platform filters the interactive electronic posts displayed on the created electronic community boards based on filter criteria, for example, a type of the interactive electronic post, a type of the electronic community board, location of the user, etc. Consider an example where a user is a member of a community associated with restaurants in the country. The electronic community board management platform displays all the interactive electronic posts in that particular community to the user. If the user wants to view only the interactive electronic posts associated with restaurants offering Chinese food, the electronic community board management filters the interactive electronic posts and displays the interactive electronic posts associated with restaurants offering Chinese food.

In an embodiment, the electronic community board management platform categorizes and manages the created interactive electronic posts on the created electronic community boards. The electronic community board management platform categorizes the created interactive electronic posts based on the content of the created interactive electronic posts. For example, if the content of the interactive electronic posts is related to sports, the electronic community board management platform categorizes the interactive electronic posts under a sports category and displays those interactive electronic posts on an electronic community board associated with sports. Consider another example of a university with many departments. Each department in the university has an electronic community board. The electronic community board management platform allows the administrator of the university to categorize the interactive electronic posts based on the different departments of the university and then displays the categorized interactive electronic posts on the corresponding electronic community boards of the departments. In another example, the electronic community board management platform categorizes the interactive electronic posts on billboards located in a high traffic area based on the location of the billboards, the traffic status, etc. A controller of the billboard can choose to categorize electronic posts based on the importance of the interactive electronic posts using the electronic community board management platform. The electronic community board management platform displays the interactive electronic posts on the billboards based on the categorization and the settings chosen by the controller.

In another embodiment, the electronic community board management platform targets the created interactive electronic posts to one or more communities based on targeting criteria. The targeting criteria comprise, for example, one or more of type of communities, content of the interactive electronic posts, type of the electronic community boards, user or member profiles, user settings, a location of each of the communities, a location defined in each of the created interactive electronic posts, a location of the user associated with one or more communities. The geographic or location based criteria comprise, for example, one or more of the detected location of the user or the location selected by the user, previously stored location preferences, etc. In an example, if a user wants to rent out his/her apartment, the user can create an interactive electronic post with details of the apartment such as the number of rooms in the apartment, facilities available, location of the apartment, etc., along with some pictures showing the different rooms of the apartment via the GUI of the electronic community board management platform. The electronic community board management platform displays the created interactive electronic post on electronic community boards located within the user's township or geographical area to target tenants in the user's location based on the address mentioned in the interactive electronic post. In another example, a user who has started a new tuition center can create interactive electronic posts using the electronic community board management platform to target students residing near the tuition center. In another example, an advertising agency can target advertisements related to local services via interactive electronic posts to a user based on his/her location using the electronic community board management platform.

In another embodiment, the electronic community board management platform provides a search engine configured to allow the users to search for the created electronic community boards and the interactive electronic posts on the created electronic community boards simultaneously based on search criteria. The search criteria comprise, for example, one or more of a location of each of the communities, a location defined in each of the created interactive electronic posts, a location of the electronic device configured to display the electronic community boards and/or the interactive electronic posts. The electronic community board management platform allows a user to search for the interactive electronic posts on multiple created electronic community boards of which he/she is a member simultaneously via the search engine. In an example, a user who is a news reporter and has recently joined the electronic community board management platform can search for electronic community boards related to different news agencies. The electronic community board management platform displays all the electronic community boards related to the different news agencies. The user can then choose to join the electronic community boards of the news agencies in which he/she is interested. In another example, if a student is looking to buy some furniture for his/her apartment, he/she can login to the electronic community board management platform and search for furniture shops in his/her location using a postcode of his/her area. The electronic community board management platform displays a list of electronic posts related to furniture services in the user's area on the GUI. In another example, the electronic community board management platform allows a user to search for all the theaters near his/her location showcasing a particular movie. In another example, a user in the vicinity of a display device that is positioned in a particular geographical location and that communicates with the electronic community board management platform via a network can search for electronic posts associated with that geographical location using the search engine.

The electronic community board management platform shares the created interactive electronic posts with one or more users associated with one or more communities based on sharing options provided by the electronic community board management platform. The sharing options comprise, for example, one or more of privately sharing the created interactive electronic posts on the created electronic community boards, sharing the created interactive electronic posts via electronic mail, posting the created interactive electronic posts on one or more social networking platforms, etc. The electronic community board management platform allows a user to privately share the created interactive electronic posts. The user can also change the privacy settings on the electronic community board management platform to selectively post the created interactive electronic posts on the created electronic community boards. The electronic community board management platform also allows the user to send an interactive electronic post to other users, for example, via email, or post the interactive electronic post on social media platforms. For example, if a user wants to host a party, the user can choose to invite his/her friends by creating an invitation card or an interactive electronic post using the electronic community board management platform. The user can change the privacy settings for privately sharing the interactive electronic post to a few close friends. The electronic community board management platform then shares the created interactive electronic post privately with the selected friends, for example, via Facebook® or through email.

In an embodiment, the electronic community board management platform embeds the created electronic community boards on one or more websites hosted by one or more communities. The electronic community board management platform provides appropriate code snippets to a website administrator of a community. The website administrator includes the code snippets in the source code of the website. The electronic community board management platform then delivers appropriate content to the client website with the appropriate display criteria comprising, for example, community identification, geography or location of the user, etc. The user can interact with the embedded version of the electronic community board management platform in a manner similar to interacting with the primary electronic community board management platform website on a native electronic device.

In an embodiment, the electronic community board management platform integrates multiple social networking platforms within the electronic community board management platform via the network for facilitating creation of electronic community boards and creation of interactive electronic posts, and sharing of the created interactive electronic posts via the network. Examples of social networking platforms comprise, for example, blogs such as Slogger, LiveJournal, Open Diary, TypePad® of Six Apart Ltd., WordPress® of WordPress Foundation, ExpressionEngine® of PMachine, Inc., Xanga® of Xanga.com, Inc.; micro-blogging and presence applications comprising, for example, Twitter® of Twitter, Inc., Plurk, Tmblr.® of Tumblr, Inc., Jaiku® of Google, Inc., Fmylife®; social networking such as Bebo® of Bebo, Inc., Facebook® of Facebook, Inc., Linkedin® of Linkedin Corporation, MySpace® of MySpace Inc., Orkut® of Google, Inc., Skyrock®, Hi5® of Hi5 Networks, Inc., Ning® of Ning, Inc., Elgg and social network aggregation applications such as NutshellMail, FriendFeed® of Facebook, Inc., etc. In another embodiment, the electronic community board management platform allows a user to sign up or register to the electronic community board management platform through a social networking platform.

In another embodiment, the electronic community board management platform provides one or more incentives to users, for example, based on the number of created interactive electronic posts shared by each user and the number of electronic community boards engaged by each user. As used herein, the term “incentives” refers to online and/or offline items of value, for example, gift cards, gift certificates, loyalty cards, reward cards, virtual points, virtual currencies, commissions, access to rich media content, etc., that can be allocated and converted into real or virtual points, currency, etc. For example, the electronic community board management platform provides an option to generate affiliate commissions for community leaders using a visual bulletin board approach. The community leaders are provided with targeted electronic posts which are to be distributed to the members of their community. The electronic community board management platform provides affiliate commissions to the community leaders for facilitating the engagement of their community.

The electronic community board management platform manages 107 actions triggered by the user inputs received from the user device of the user or via other electronic devices on the generated unique collective electronic community board. For example, the electronic community board management platform manages actions such as creation of electronic bulletins, classified listings boards, electronic work spaces, etc., for public communities and private communities, joining or linking of multiple electronic community boards, creating the interactive electronic posts or posting messages simultaneously to multiple electronic community boards, viewing the interactive electronic posts from multiple electronic community boards, searching, filtering, and sorting of electronic community boards and the interactive electronic posts, etc. In an embodiment, the electronic community board management platform generates and transmits notifications associated with the actions triggered by the user inputs received from the user via the electronic device on the generated unique collective electronic community board. The user can therefore receive notifications of new interactive electronic posts, updated interactive electronic posts, etc., from other board members via the electronic community board management platform.

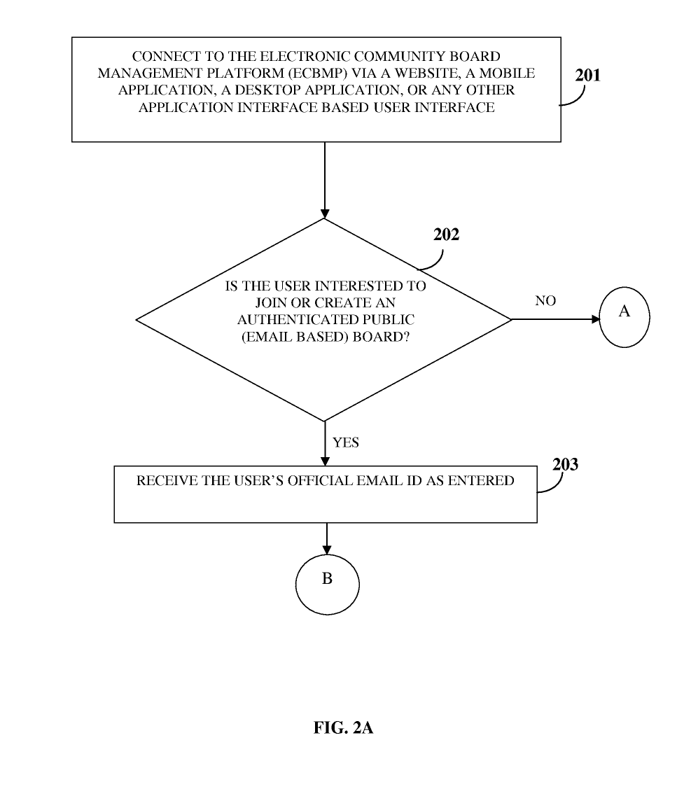

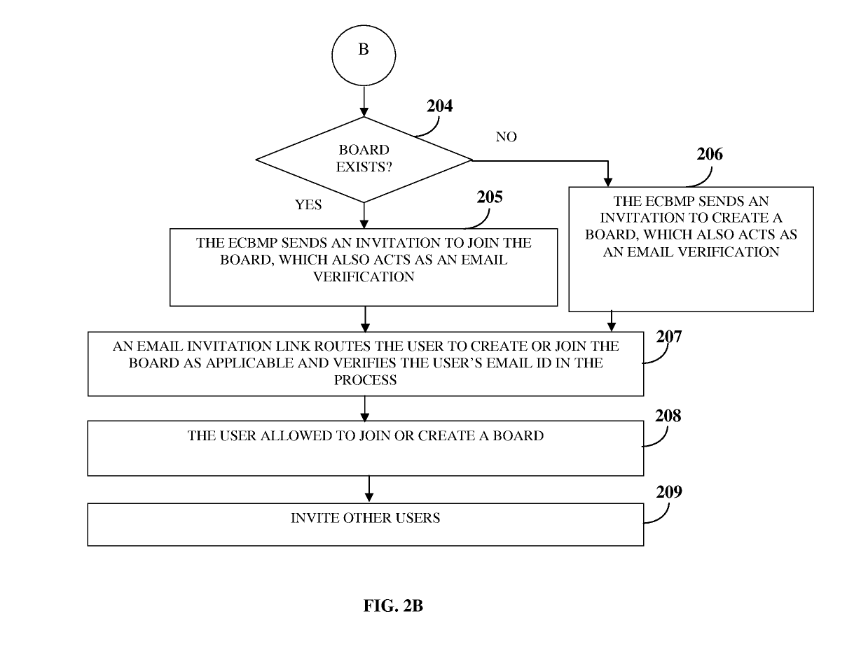

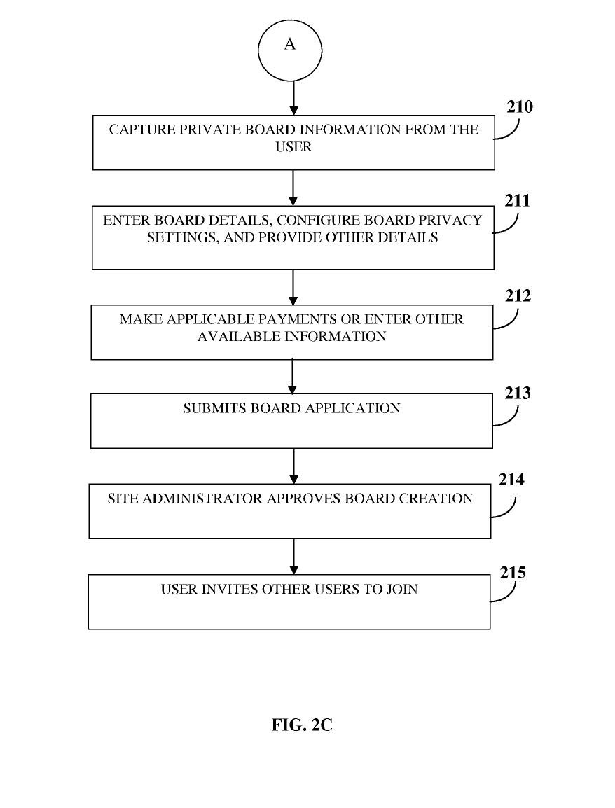

FIGS. 2A-2C exemplarily illustrate a flowchart comprising the steps performed by the electronic community board management platform (ECBMP) for creating an electronic community board. As exemplarily illustrated in FIG. 2A, a user connects 201 to the electronic community board management platform, for example, through a web browser, a website, or a widget that is embedded into other websites, a browser plug-in, a mobile application, a desktop application, a PC/MAC application, an application programming interface or any other application interface based user interface, a third party application, or through dedicated or shared devices such as flat panel display boards posted in community buildings and other public places as disclosed in the detailed description of FIG. 1. The user accesses the electronic community board management platform to join or create electronic community boards, create or view interactive electronic posts on multiple electronic community boards simultaneously, etc., through mobile devices or through an application installed on the user device or on other electronic devices. In an example, third party applications can access and deliver the features of the electronic community board management platform to an electronic device using an application programming interface (API) provided by the electronic community board management platform.

The electronic community board management platform captures a user's interest to join or create 202 electronic community boards, for example, a public electronic community board where a user joins the electronic community board at his/her discretion, a private electronic community board based on a security code validation or moderator approval, or an official electronic mail (email) identifier (ID) or address domain authenticated electronic community board. If the user enters an official email ID, the electronic community board management platform receives 203 the official email ID entered by the user and checks 204 whether an electronic community board associated with the user's email address domain already exists. As exemplarily illustrated in FIG. 2B, if an electronic community board associated with the user's email address domain already exists, the electronic community board management platform sends 205 an invitation to the user to join the electronic community board. The electronic community board management platform also verifies the user's email ID via the invitation. If the electronic community board associated with the user's email address domain does not exist, the electronic community board management platform sends 206 an invitation to the user to create an electronic community board, which may also act as an email verification.

Based on the type of invitation, the electronic community board management platform guides the user to either create or join an electronic community board that is associated with the email address domain the user originally entered. The email invitation link routes 207 the user to create or join the electronic community board as applicable and verifies the user's email ID in the process. On successful email verification, the electronic community board management platform allows 208 the user to join or create the electronic community board. The electronic community board management platform then prompts the user to invite 209 other users to join the electronic community board. The users can join multiple electronic community boards either at the time of becoming a member of the electronic community board management platform or during various usage sessions.

When the user joins the electronic community boards, the electronic community board management platform allows the user to view multiple interactive electronic posts, also referred herein to as postings or flyers or “hoots”, for example, a classified, an advertorial, an event, a personal listing, etc., across multiple electronic community boards through a graphical user interface (GUI). The interactive electronic post that a user creates via the GUI is simultaneously posted to multiple electronic community boards of which the user is a member. The user can choose to further promote interactive electronic posts, for example, by paying a hosting company on other electronic community boards of which he/she is not a member. In an embodiment, the electronic community board management platform enables the user to view the created interactive electronic posts across multiple electronic community boards via an application programming interface (API) output of text data and relevant links. The electronic community board management platform allows users to create multiple electronic community boards that can be overlapped or nested, thereby allowing users to engage communities within communities as required. Each electronic community board will have users join and users will have the ability to make their interactive electronic posts visible to multiple electronic community boards simultaneously based on their preferences.

As exemplarily illustrated in FIG. 2C, if the user originally wishes to create an electronic community board, the electronic community board management platform captures 210 private board information comprising, for example, a unique board code, board details, board privacy settings, etc., from the user via the GUI. The user enters 211 electronic community board details, configures electronic community board privacy settings, and provides other details, etc., via the GUI. If a payment is required for creating a private electronic community board, the electronic community board management platform prompts the user to make 212 applicable payments before an electronic community board is created for the user or enter other available information. After entering the board information, the user finalizes and submits 213 the board application to the electronic community board management platform via the GUI. In an embodiment, the site administrator of the electronic community board management platform conducts an approval procedure for approving 214 the board application for creation of the electronic community board. In an embodiment, the user's electronic community board application does not require an administrator approval but the user will have to invite a predetermined number of prospective members to qualify as a member of the electronic community board. In another embodiment, administrator approval is not applicable for paid boards. The electronic community board management platform then prompts the user to invite 215 other users to join the electronic community board.

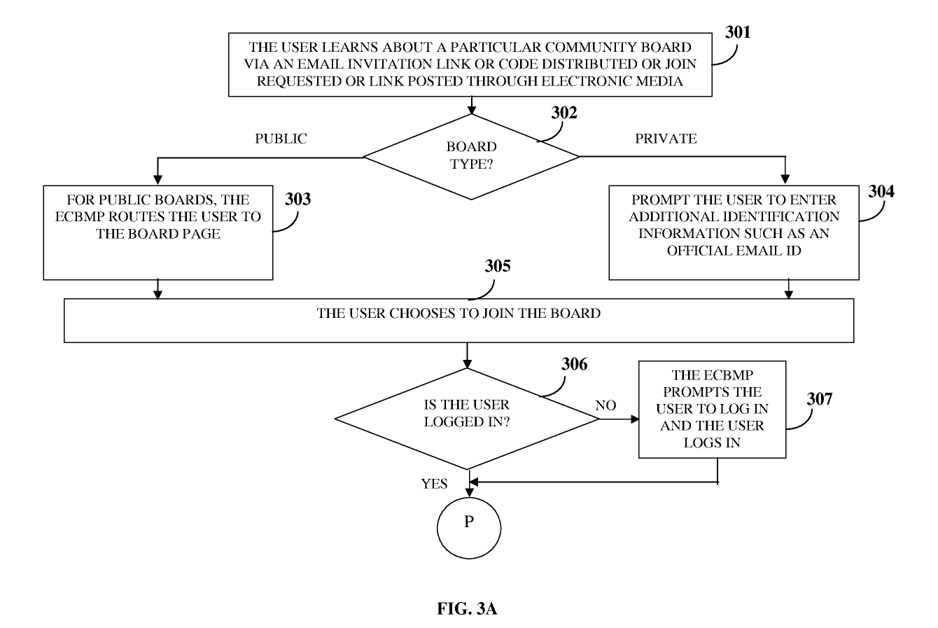

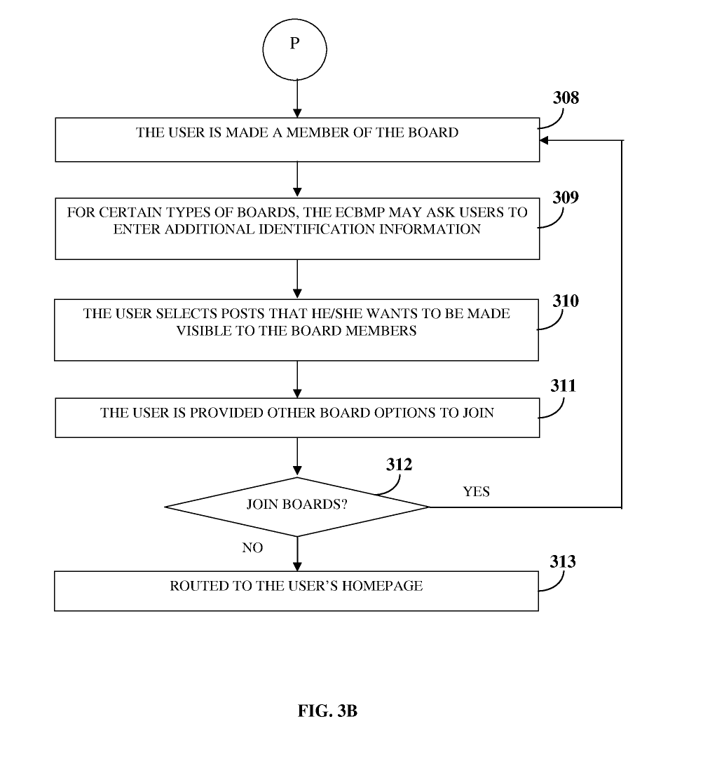

FIGS. 3A-3B exemplarily illustrate a flowchart comprising the steps performed by the electronic community board management platform (ECBMP) for enabling a user to join an electronic community board. The electronic community board management platform enables the user to join various electronic community boards that are already created by other users. The electronic community board management platform introduces the user to a particular electronic community board via various media sources, for example, an electronic mail (email) invitation, an online search, word of mouth, flyers, etc. The user can therefore learn 301 about a particular electronic community board, for example, via an email invitation link, a distributed code, a join request, or a link posted through electronic media. The electronic community board management platform checks 302 for the type of the electronic community board that the user wishes to join.

In the case of public electronic community boards, the electronic community board management platform routes 303 the user to an electronic community board page. In the case of private or authenticated electronic community boards, the electronic community board management platform prompts 304 the user to enter additional identification information such as an official email identifier (ID) or address or an electronic community board code prior to viewing the electronic community board page. When the user is appropriately authorized to view an electronic community board, the user can view the electronic community board details on the graphical user interface (GUI) of the electronic community board management platform or on another website. If the user chooses 305 to join an electronic community board, the user can select a “Join” option provided on the GUI to become a member of the electronic community board. The electronic community board management platform checks 306 whether the user is logged into the electronic community board. If the user is not logged into the electronic community board, the electronic community board management platform prompts 307 the user to log in.

Once the user is logged into the electronic community board, the electronic community board management platform makes 308 the user a member of the electronic community board. The electronic community board management platform requires the user to enter 309 additional identification or membership information for certain types of electronic community boards. The electronic community board management platform allows the user to search for interactive electronic posts, for example, based on a postal code or a zip code of the user's location. The electronic community board management platform prompts the user to select 310 interactive electronic posts that are to be displayed on the electronic community board the user is joining. For example, the user selects the interactive electronic posts that he/she wants to be made visible to the other board members. If the user is a new user, the electronic community board management platform provides 311 other board options on the GUI to enable the user to join other electronic community boards in which the user may be interested. The user may choose to skip the step of joining other electronic community boards. The electronic community board management platform checks 312 whether the user wishes to join other electronic community boards. If the user wishes to join the other electronic community boards, the electronic community board management platform repeats the steps 308, 309, 310, and 311 disclosed above. If the user does not wish to join the other electronic community boards, the electronic community board management platform routes 313 the user to his/her homepage.

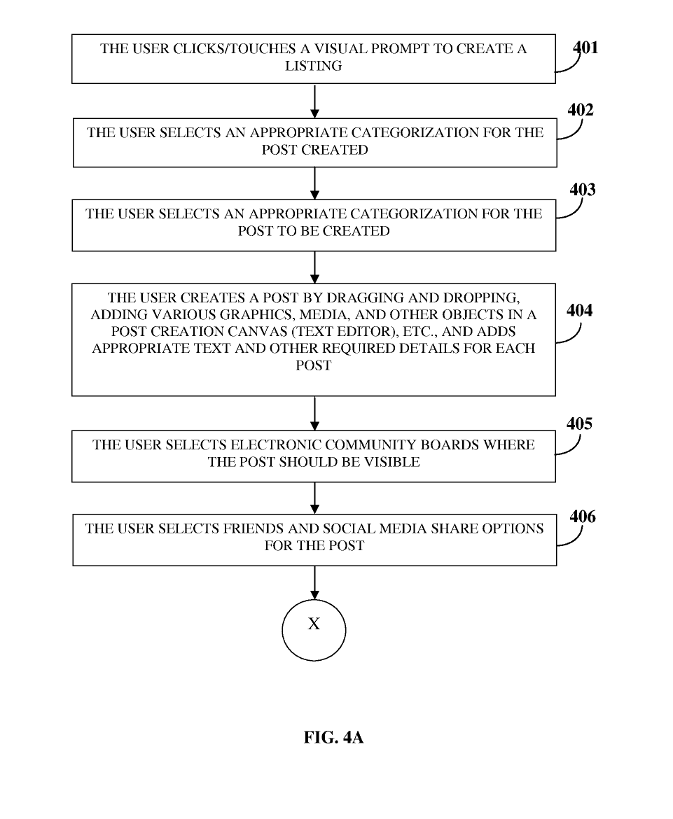

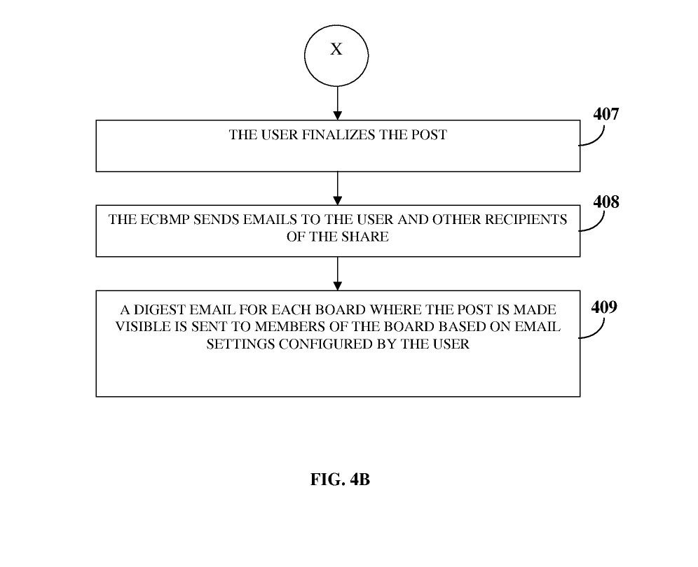

FIGS. 4A-4B exemplarily illustrate a flowchart comprising the steps performed by the electronic community board management platform for creating interactive electronic posts for selective display on multiple electronic community boards. The electronic community board management platform provides the user with a visual prompt to create 401 a posting, listing, or an interactive electronic post by clicking or touching an interface element on the graphical user interface (GUI) provided by the electronic community board management platform. The electronic community board management platform prompts the user to select 402 an appropriate posting category for the interactive electronic post created to allow the electronic community board management platform to easily organize the interactive electronic post. The electronic community board management platform also prompts the user to select 403 an appropriate posting category for the interactive electronic post to be created. The user uses a JavaScript® and browser-based post creation editor that allows users to create visual multimedia enriched interactive electronic posts. The user creates 404 the interactive electronic post, for example, by dragging and dropping media content, adding various graphics, media and other objects in a post creation canvas or text editor, and adds appropriate text and other required details for each interactive electronic post. The interactive electronic posts are made up of one or a combination of various types of media formats such as text, images, audio, video, etc. In an example, the interactive electronic post is created as one or a combination of audiovisual detail.

The electronic community board management platform allows the user to select 405 the electronic community boards where the interactive electronic post should be visible. That is, the electronic community board management platform allows the user to select visibility options for the interactive electronic post to allow the interactive electronic post to be made visible only to those electronic community boards to which the user wishes the interactive electronic post to be made visible. The electronic community board management platform then prompts the user to select 406 friends and social media share options for the interactive electronic post. That is, the electronic community board management platform prompts the user to select sharing of the interactive electronic posts to friends via various social media sources. At this point, the user finalizes 407 the interactive electronic post and the electronic community board management platform processes the images and other multimedia added to the interactive electronic post. The electronic community board management platform sends 408 electronic mails (emails) to the user confirming that the interactive electronic post was created and appropriately posted. The electronic community board management platform also sends 408 emails to other recipients of the interactive electronic post and social media outlets as selected by the user. The electronic community board management platform sends 409 a digest email of all interactive electronic posts made to various electronic community boards to the board members of the electronic community board at a predetermined frequency based on email settings configured by the user.

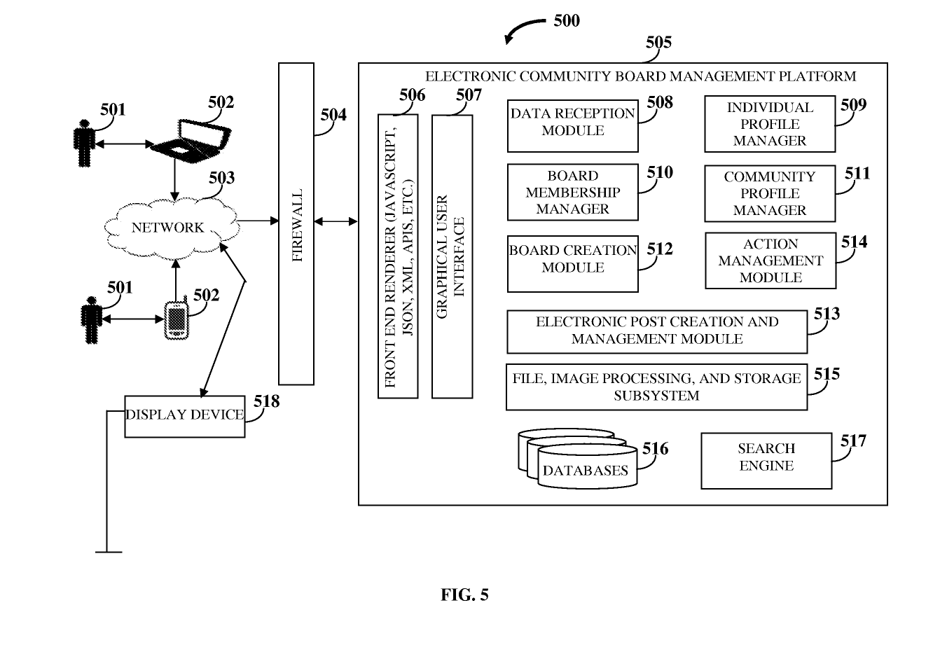

FIG. 5 illustrates a computer implemented system 500 for simultaneously engaging multiple electronic community boards associated with multiple communities. The high level architecture of the electronic community board management platform 505 is exemplarily illustrated in FIG. 5. The computer implemented system 500 disclosed herein is a networked computer, web, mobile device and application programming interface (API) based system. The computer implemented system 500 disclosed herein comprises the electronic community board management platform 505 accessible by multiple electronic devices 502 via a network 503. A user 501 with a user device or another electronic device 502, for example, a personal computer with a browser, an application front end, etc., or with mobile device access through native or third party applications, accesses the electronic community board management platform 505 through a firewall 504 and a load balancer (not shown) via the network 503. The network 503 is, for example, the internet, an intranet, a wired network, a wireless network, a network that implements Wi-Fi® of the Wireless Ethernet Compatibility Alliance, Inc., etc., as disclosed in the detailed description of FIG. 1.

The electronic community board management platform 505 comprises at least one processor configured to execute modules, for example, 508, 512, 513, 514, 517, etc., and subsystems 506, 509, 510, 511, 515, etc., of the electronic community board management platform 505. The electronic community board management platform 505 further comprises a non-transitory computer readable storage medium communicatively coupled to the processor. The non-transitory computer readable storage medium stores the modules, for example, 508, 512, 513, 514, 517, etc., and the subsystems 506, 509, 510, 511, 515, etc., of the electronic community board management platform 505. The subsystems, for example, 506, 509, 510, 511, 515, etc., of the electronic community board management platform 505 implement or execute the overall functionality of the electronic community board management platform 505. The subsystems comprise, for example, a frontend renderer 506, an individual profile manager 509, a community profile manager 511, a board membership manager 510, a file, image processing and storage subsystem 515, and multiple databases 516.

Depending on the type of front end application, the frontend renderer 506 is an application created by different technologies, for example, JavaScript®, JavaScript object notation (JSON), an extensible markup language (XML), application programming interfaces (APIs), a device specific language, etc. The frontend renderer 506 renders user facing screens or graphical user interfaces (GUI) 507 to allow a user 501 or an application interface to interact with the modules, for example, 508, 512, 513, 514, 517, etc., of the electronic community board management platform 505. The GUI 507 is, for example, a webpage of a website hosted by the electronic community board management platform 505, an online web interface, a web based downloadable application interface, a mobile based downloadable application interface, etc. The electronic community board management platform 505 comprises a data reception module 508, a board creation module 512, an electronic post creation and management module 513, an action management module 514, and a search engine 517. The data reception module 508 receives user information and board information via the GUI 507 provided by the electronic community board management platform 505. The individual profile manager 509 manages the user information, for example, login information, social media account information, images, preferences, contact information, address book information, etc. The individual profile manager 509 is invoked when the user information is required. The individual profile manager 509 provides access to an individual user's 501 board memberships, which are managed by the board membership manager 510.

The community profile manager 511 and/or the board membership manager 510 subsystem manage the metadata associated with the board information, for example, core board profiles, profile images, location details etc. The community profile manager 511 manages aggregate information, for example, the count, demographic information, etc., about each electronic community board to enable users 501 to obtain details about each electronic community board. The board creation module 512 creates one or more electronic community boards associated with one or more communities using the received user information and board information. The board creation module 512 further controls access to the created electronic community boards based on the received board information. The action management module 514 transmits electronic invitations to one or more users 501 via the network 503 for enabling the creation of the electronic community boards or joining of one or more of the created electronic community boards. The board creation module 512 further generates a unique collective electronic community board for each user 501 associated with one or more communities using the created electronic community boards. The board creation module 512 further embeds the created electronic community boards on one or more websites hosted by one or more communities.

The electronic post creation and management module 513 creates one or more interactive electronic posts in one or more media formats based on media inputs comprising, for example, one or more of themes, layouts, and media content received from the electronic device 502 or the user device of each of the users 501 associated with one or more communities. The electronic post creation and management module 513 manages creation, deletion, edition, and changes to the interactive electronic posts created on the electronic community board management platform 505. In an embodiment, the electronic post creation and management module 513 uploads external electronic posts in multiple formats from one or more sources, for example, user devices, other websites, third party applications, third party services and websites, data sources which transfer data through files in multiple formats such as JavaScript object notation (JSON), extensible markup language (XML), etc., and integrated document editors and selectively displays the uploaded external electronic posts on the created electronic community boards. In another embodiment, the electronic post creation and management module 513 provides post enhancing options for adjusting characteristics of each of the created interactive electronic posts. The electronic post creation and management module 513 further automatically calculates a cost associated with the adjustment of the characteristics of each of the created interactive electronic posts and executes a payment transaction based on the calculated cost. The electronic post creation and management module 513 receives payment information, for example, credit card information, debit card information, etc., from the electronic device 502 and charges the user 501 based on the calculated cost.

The electronic post creation and management module 513 also processes various media components of the interactive electronic posts created, and creates thumbnails and other information required for the posting of the interactive electronic posts. The electronic post creation and management module 513 types codes and categorizes each interactive electronic post for easy search, retrieval, and filtering. The electronic post creation and management module 513 further selectively displays the created interactive electronic posts on the created electronic community boards based on display criteria comprising, for example, one or more of community type, privacy settings, user preferences, content of the created interactive electronic posts, type of the created electronic community boards, a location of the user 501 associated with one or more communities, a location of each community, a location defined in each of the created interactive electronic posts, a location of the electronic device, for example, 518 configured to display the electronic community boards and/or the interactive electronic posts, etc.

In an embodiment, the electronic post creation and management module 513 categorizes and manages the created interactive electronic posts on the created electronic community boards. In another embodiment, the electronic post creation and management module 513 filters the created interactive electronic posts displayed on the created electronic community boards based on filter criteria, for example, the type of interactive electronic post, the type of electronic community board, location of the user 501, etc. In another embodiment, the electronic post creation and management module 513 requests approval from the user 501 for simultaneously displaying the created interactive electronic posts on the created electronic community boards. The electronic post creation and management module 513 further shares the created interactive electronic posts with one or more users 501 associated with one or more communities based on sharing options provided by the electronic community board management platform 505. The sharing options comprise, for example, one or more of privately sharing the created interactive electronic posts on the created electronic community boards, sharing the created interactive electronic posts via electronic mail, posting the created interactive electronic posts on one or more social networking platforms, etc. In another embodiment, the electronic post creation and management module 513 targets the created interactive electronic posts to one or more communities based on targeting criteria comprising, for example, one or more of a location of each community, a location defined in each of the created interactive electronic posts, a location of the user 501 associated with one or more communities, etc. The board creation module 512 further displays the generated unique collective electronic community board and the created interactive electronic posts on multiple electronic devices, for example, 502, 518, etc. The data reception module 508 receives user inputs and gestures of multiple different types from the electronic devices, for example, 502, 518, etc.

The user 501 is required to join an electronic community board to view the interactive electronic posts available to that electronic community board. The board membership manager 510 manages memberships to the electronic community boards. The electronic community board management platform 505 allows board administrators to remove or ban users 501 from an electronic community board. The action management module 514 manages actions triggered by the user inputs received from the electronic devices, for example, 518, etc., or the user device, for example, 502 of each of the users 501 on the generated unique collective electronic community board. In an embodiment, the action management module 514 generates and transmits notifications associated with the actions triggered by the user inputs received from the electronic device, for example, 502, 518, etc., on the generated unique collective electronic community board. The search engine 517 allows the users 501 to search for the created electronic community boards and the created interactive electronic posts on the created electronic community boards simultaneously based on search criteria comprising, for example, one or more of a community location, a location defined in an electronic post, a location of the electronic device, for example, 518 configured to display the electronic community boards and/or the interactive electronic posts.

The data supporting the electronic community board management platform 505 is stored in multiple databases 516 and data models. The database 516 is, for example, a structured query language (SQL) data store or a not only SQL (NoSQL) data store such as the Microsoft® SQL Server®, the Oracle® servers, the MySQL® database of MySQL AB Company, the mongoDB® of 10 gen, Inc., the Neo4j graph database, the Cassandra database of the Apache Software Foundation, the HBase™ database of the Apache Software Foundation, an in-memory database, etc. In an embodiment, the database 516 can also be a location on a file system. The database 516 is any storage area or medium that can be used for storing data and files. In another embodiment, the database 516 can be remotely accessed by the electronic community board management platform 505 via the network 503. In another embodiment, the database 516 is configured as a cloud based database implemented in a cloud computing environment, where computing resources are delivered as a service over the network 503, for example, the internet. In an embodiment, the electronic community board management platform 505 allows authorized users or a board administrator to access data and files in the database 516 through an application programming interface (API) for delivering various value added services to other users in the community.

The core data structure relationships between the data models enable the functionality of the electronic community board management platform 505. The file, image processing and storage subsystem 515 processes media files, user files, uploads, etc. The electronic post creation and management module 513 invokes the processing of the media files, user files, uploads, etc. Other subsystems may also be involved in the processing of the media files, user files, uploads, etc. The user files are stored on a storage area network, for example, a cloud based storage network, an intranet based storage network, etc., and are delivered to the electronic community board management platform 505 via a content delivery network, for example, CloudFront® of Amazon Technologies, Inc., Amazon Web Services® of Amazon Technologies, Inc., Rackspace® cloud files, etc.

In an embodiment, the electronic community board management platform 505 communicates with a display device 518 positioned at a particular geographical location via the network 503. The display device 518 receives electronic posts and other requested information from the electronic community board management platform 505 via the network 503 and displays the information to the users 501 in that geographical location. The display device 518 receives user inputs and gestures from the user 501 and transmits the user inputs and the gestures to the electronic community board management platform 505 via the network 503 for processing.

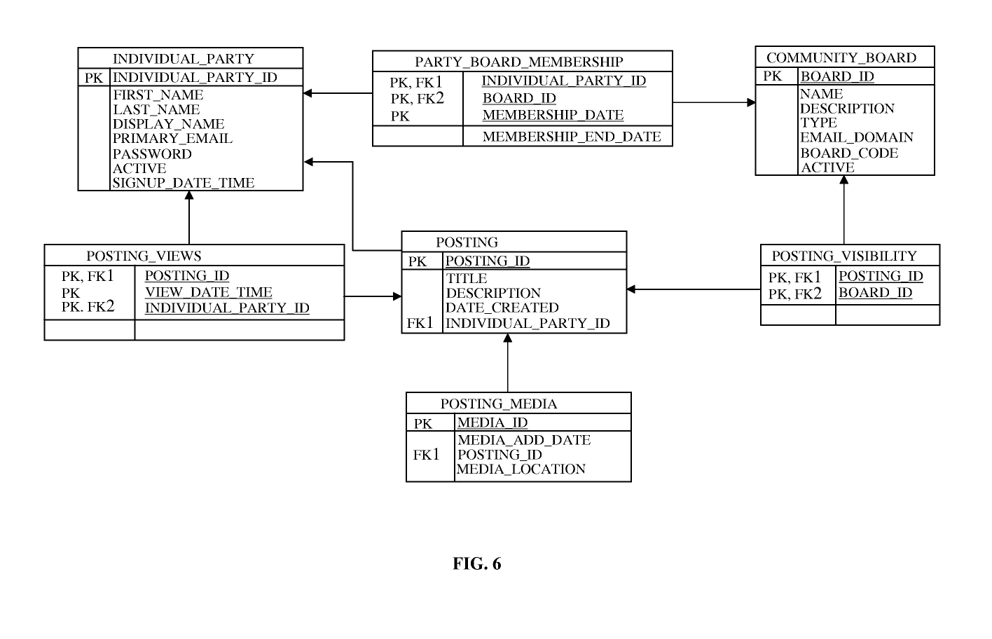

FIG. 6 exemplarily illustrates a data model outlining key data relationships among various elements of the electronic community board management platform 505 exemplarily illustrated in FIG. 5. Each of the communities and the sub-communities can have an electronic community board that various members of the community can join. The electronic community board management platform 505 posts the interactive electronic posts created by the users 501 on multiple electronic community boards based on data stored in a posting visibility table in a database 516 maintained by the electronic community board management platform 505. The posting table in the database 516 comprises a posting identity, a title of the interactive electronic post, a description, a date of creation of the interactive electronic post, and the user identity. The posting visibility table maintains the posting identity and the identity of the electronic community board under which the interactive electronic post has been posted. The data model exemplarily illustrated in FIG. 6 also shows links between the electronic posts, the users 501 who created the electronic posts, and the electronic community boards where the electronic posts are posted.

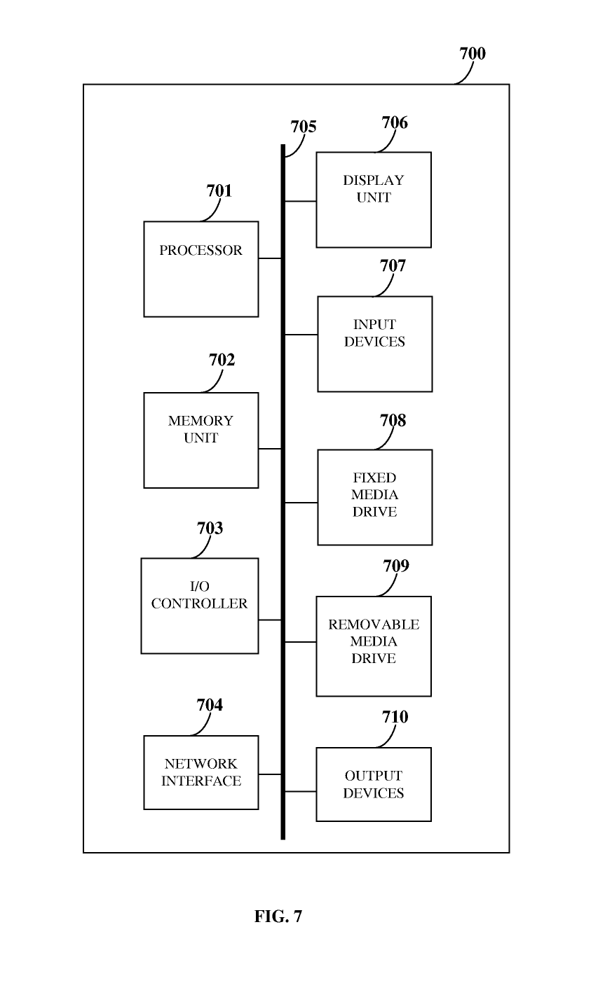

FIG. 7 exemplarily illustrates the architecture of a computer system 700 employed by the electronic community board management platform 505, exemplarily illustrated in FIG. 5, for simultaneously engaging multiple electronic community boards associated with multiple communities. The electronic community board management platform 505 of the computer implemented system 500 exemplarily illustrated in FIG. 5 employs the architecture of the computer system 700 exemplarily illustrated in FIG. 7. The computer system 700 is programmable using a high level computer programming language. The computer system 700 may be implemented using programmed and purposeful hardware. The electronic community board management platform 505 communicates with the electronic devices 502 via the network 503, for example, a short range network or a long range network. The computer system 700 comprises, for example, a processor 701, a non-transitory computer readable storage medium such as a memory unit 702 for storing programs and data, an input/output (I/O) controller 703, a network interface 704, a data bus 705, a display unit 706, input devices 707, a fixed media drive 708, a removable media drive 709 for receiving removable media, output devices 710, etc.

The term “processor” refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 701 may also be implemented as a processor set comprising, for example, a general purpose microprocessor and a math or graphics co-processor. The processor 701 is selected, for example, from the Intel® processors such as the Itanium® microprocessor or the Pentium® processors, Advanced Micro Devices (AMD®) processors such as the Athlon® processor, UltraSPARC® processors, microSPARC™ processors, Hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, etc. The electronic community board management platform 505 disclosed herein is not limited to a computer system 700 employing a processor 701. The computer system 700 may also employ a controller or a microcontroller. The processor 701 executes the modules, for example, 508, 512, 513, 514, 517, etc., and the subsystems 506, 509, 510, 511, 515, etc., of the electronic community board management platform 505.

The memory unit 702 is used for storing programs, applications, and data. For example, the data reception module 508, the board creation module 512, the individual profile manager 509, the board membership manager 510, the community profile manager 511, the electronic post creation and management module 513, the action management module 514, the file, image processing and storage subsystem 515, etc., of the electronic community board management platform 505 are stored in the memory unit 702 of the computer system 700. The memory unit 702 is, for example, a random access memory (RAM) or another type of dynamic storage device that stores information and instructions for execution by the processor 701. The memory unit 702 also stores temporary variables and other intermediate information used during execution of the instructions by the processor 701. The computer system 700 further comprises a read only memory (ROM) or another type of static storage device that stores static information and instructions for the processor 701.

The network interface 704 enables connection of the computer system 700 to the network 503. For example, the electronic community board management platform 505 connects to the network 503 via the network interface 704. In an embodiment, the network interface 704 is provided as an interface card also referred to as a line card. The network interface 704 comprises, for example, one or more of an infrared (IR) interface, an interface implementing Wi-Fi® of the Wireless Ethernet Compatibility Alliance, Inc., a universal serial bus (USB) interface, a FireWire® interface of Apple, Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The I/O controller 703 controls input actions and output actions performed by the electronic community board management platform 505. The data bus 705 permits communications between the modules, for example, 508, 512, 513, 514, 517, etc., and the subsystems 506, 509, 510, 511, 515, etc., of the electronic community board management platform 505.

The display unit 706, via the graphical user interface (GUI) 507, displays information, display interfaces, user interface elements such as text fields, checkboxes, text boxes, windows, etc., for allowing a user 501 to enter user information, board information, etc., for creating, displaying, sharing, searching, filtering, and managing flyers or electronic posts. The display unit 706 comprises, for example, a liquid crystal display, a plasma display, an organic light emitting diode (OLED) based display, etc. The input devices 707 are used for inputting data into the computer system 700. The input devices 707 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc. An administrator of the electronic community board management platform 505 uses the input devices 707 to provide inputs to the electronic community board management platform 505.

Computer applications and programs are used for operating the computer system 700. The programs are loaded onto the fixed media drive 708 and into the memory unit 702 of the computer system 700 via the removable media drive 709. In an embodiment, the computer applications and programs may be loaded directly via the network 503. Computer applications and programs are executed by double clicking a related icon displayed on the display unit 706 using one of the input devices 707. The output devices 710 output the results of operations performed by the electronic community board management platform 505. For example, the electronic community board management platform 505 displays the interactive electronic posts on the electronic community boards or the unique collective electronic community board using the output devices 710.

The processor 701 executes an operating system, for example, the Linux® operating system, the Unix® operating system, any version of the Microsoft® Windows® operating system, the Mac OS of Apple Inc., the IBM® OS/2, VxWorks® of Wind River Systems, inc., QNX Neutrino® developed by QNX Software Systems Ltd., Palm OS®, the Solaris operating system developed by Sun Microsystems, Inc., the Android operating system, Windows Phone® operating system of Microsoft Corporation, BlackBerry® operating system of Research in Motion Limited, the iOS operating system of Apple Inc., the Symbian® operating system of Symbian Foundation Limited, etc. The computer system 700 employs the operating system for performing multiple tasks. The operating system is responsible for management and coordination of activities and sharing of resources of the computer system 700. The operating system further manages security of the computer system 700, peripheral devices connected to the computer system 700, and network connections. The operating system employed on the computer system 700 recognizes, for example, inputs provided by an administrator using one of the input devices 707, the output display, files, and directories stored locally on the fixed media drive 708, for example, a hard drive. The operating system on the computer system 700 executes different programs using the processor 701. The processor 701 and the operating system together define a computer platform for which application programs in high level programming languages are written.

The processor 701 retrieves instructions for executing the modules, for example, 508, 512, 513, 514, 517, etc., and the subsystems 506, 509, 510, 511, 515, etc., of the electronic community board management platform 505 from the memory unit 702. A program counter determines the location of the instructions in the memory unit 702. The program counter stores a number that identifies the current position in the program of each of the modules, for example, 508, 512, 513, 514, 517, etc., and the subsystems 506, 509, 510, 511, 515, etc., of the electronic community board management platform 505. The instructions fetched by the processor 701 from the memory unit 702 after being processed are decoded. The instructions are stored in an instruction register in the processor 701. After processing and decoding, the processor 701 executes the instructions. For example, the data reception module 508 defines instructions for receiving user information and board information via the GUI 507 provided by the electronic community board management platform 505. Furthermore, the data reception module 508 defines instructions for receiving user inputs and user gestures of multiple different types from the electronic devices 502. The board creation module 512 defines instructions for creating one or more electronic community boards associated with one or more of the communities using the received user information and board information. The action management module 514 defines instructions for transmitting electronic invitations to each of the users 501 via the network 503 for enabling the creation of the electronic community boards or joining one or more of the created electronic community boards. In an embodiment, the board creation module 512 defines instructions for controlling access to the created electronic community boards based on the received board information. Furthermore, the board creation module 512 defines instructions for generating a unique collective electronic community board for a user 501 associated with one or more communities using the created electronic community boards. Furthermore, the board creation module 512 defines instructions for embedding the created electronic community boards on one or more websites hosted by one or more communities.

The electronic post creation and management module 513 defines instructions for creating one or more interactive electronic posts in one or more media formats based on media inputs received from the electronic device 502. In another embodiment, the electronic post creation and management module 513 defines instructions for providing post enhancing options for adjusting characteristics, for example, the size of each of the created interactive electronic posts. In this embodiment, the electronic post creation and management module 513 defines instructions for automatically calculating the cost associated with the adjustment of the characteristics of each created interactive electronic post and executing a payment transaction based on the calculated cost. Furthermore, the electronic post creation and management module 513 defines instructions for selectively displaying the created interactive electronic posts on the created electronic community boards based on display criteria. Furthermore, the board creation module 512 defines instructions for displaying the generated unique electronic community board and the created interactive electronic posts on multiple electronic devices 502. In an embodiment, the electronic post creation and management module 513 defines instructions for uploading external electronic posts in multiple formats from one or more of multiple sources and integrated document editors and selectively displays the uploaded external electronic posts on the created electronic community boards. In another embodiment, the electronic post creation and management module 513 defines instructions for requesting approval from the user 501 for simultaneously displaying the created interactive electronic posts on the created electronic community boards. In another embodiment, the electronic post creation and management module 513 defines instructions for sharing the created interactive electronic posts with one or more users 501 associated with one or more communities based on sharing options provided by the electronic community board management platform 505.

In another embodiment, the electronic post creation and management module 513 defines instructions for categorizing and managing the created interactive electronic posts on the created electronic community boards. In another embodiment, the electronic post creation and management module 513 defines instructions for filtering the created interactive electronic posts displayed on the created electronic community boards based on filter criteria. Furthermore, the electronic post creation and management module 513 defines instructions for targeting the created interactive electronic posts to one or more communities based on targeting criteria. The action management module 514 defines instructions for managing actions triggered by user inputs received from the electronic device 502 on the generated unique collective electronic community board. In an embodiment, the action management module 514 defines instructions for generating and transmitting notifications associated with the actions triggered by the user inputs received from the electronic device 502 on the generated unique collective electronic community board. The search engine 517 defines instructions for searching for the created electronic community boards and/or the created interactive electronic posts on the created electronic community boards simultaneously.

The processor 701 of the computer system 700 employed by the electronic community board management platform 505 retrieves the instructions defined by the data reception module 508, the board creation module 512, the electronic post creation and management module 513, the action management module 514, the search engine 517, etc., of the electronic community board management platform 505, and executes the instructions, thereby performing one or more processes defined by those instructions. At the time of execution, the instructions stored in the instruction register are examined to determine the operations to be performed. The processor 701 then performs the specified operations. The operations comprise arithmetic operations and logic operations. The operating system performs multiple routines for performing a number of tasks required to assign the input devices 707, the output devices 710, and memory for execution of the modules, for example, 508, 512, 513, 514, 517, etc., and the subsystems 506, 509, 510, 511, 515, etc., of the electronic community board management platform 505. The tasks performed by the operating system comprise, for example, assigning memory to the modules, for example, 508, 512, 513, 514, 517, etc., and the subsystems 506, 509, 510, 511, 515, etc., of the electronic community board management platform 505, and to data used by the electronic community board management platform 505, moving data between the memory unit 702 and disk units, and handling input/output operations. The operating system performs the tasks on request by the operations and after performing the tasks, the operating system transfers the execution control back to the processor 701. The processor 701 continues the execution to obtain one or more outputs. The outputs of the execution of the modules, for example, 508, 512, 513, 514, 517, etc., and the subsystems 506, 509, 510, 511, 515, etc., of the electronic community board management platform 505 are displayed to the users 501 on the display unit 706 of the computer system 700.

For purposes of illustration, the detailed description refers to the electronic community board management platform 505 being run locally on the computer system 700; however the scope of the computer implemented method and system 500 disclosed herein is not limited to the electronic community board management platform 505 being run locally on the computer system 700 via the operating system and the processor 701, but may be extended to run remotely over the network 503 by employing a web browser and a remote server, a mobile phone, or other electronic devices. One or more portions of the computer system 700 may be distributed across one or more computer systems (not shown) coupled to the network 503.

Disclosed herein is also a computer program product comprising a non-transitory computer readable storage medium that stores computer program codes comprising instructions executable by at least one processor 701 for simultaneously engaging multiple electronic community boards associated with multiple communities. As used herein, the term “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor 701, except for a transitory, propagating signal.

The computer program product comprises a first computer program code for receiving user information and board information via the GUI 507; a second computer program code for creating one or more electronic community boards associated with one or more communities using the received user information and board information; a third computer program code for generating a unique collective electronic community board for each user 501 associated with one or more of the communities using the created electronic community boards; a fourth computer program code for creating one or more interactive electronic posts in one or more media formats based on media inputs received from the electronic device 502; a fifth computer program code for selectively displaying the created interactive electronic posts on the created electronic community boards based on the display criteria; and a sixth computer program code for managing actions triggered by user inputs received from the electronic device 502 on the generated unique collective electronic community board. The computer program product further comprises a seventh computer program code for displaying the generated unique collective electronic community board and the created interactive electronic posts on multiple electronic devices, for example, 502, 518, etc.; and an eighth computer program code for receiving the user inputs and gestures of different types from the electronic devices 502. The computer program product disclosed herein further comprises a ninth computer program code for automatically calculating a cost associated with an adjustment of characteristics, for example, a size of each of the created interactive electronic posts and executing a payment transaction based on the calculated cost. The computer program product disclosed herein further comprises one or more additional computer program codes for performing additional steps that may be required and contemplated for simultaneously engaging the electronic community boards associated with the communities. In an embodiment, a single piece of computer program code comprising computer executable instructions performs one or more steps of the computer implemented method disclosed herein for simultaneously engaging the electronic community boards associated with the communities.

The computer program codes comprising computer executable instructions are embodied on the non-transitory computer readable storage medium. The processor 701 of the computer system 700 retrieves these computer executable instructions and executes them. When the computer executable instructions are executed by the processor 701, the computer executable instructions cause the processor 701 to perform the steps of the computer implemented method for simultaneously engaging the electronic community boards associated with the communities.

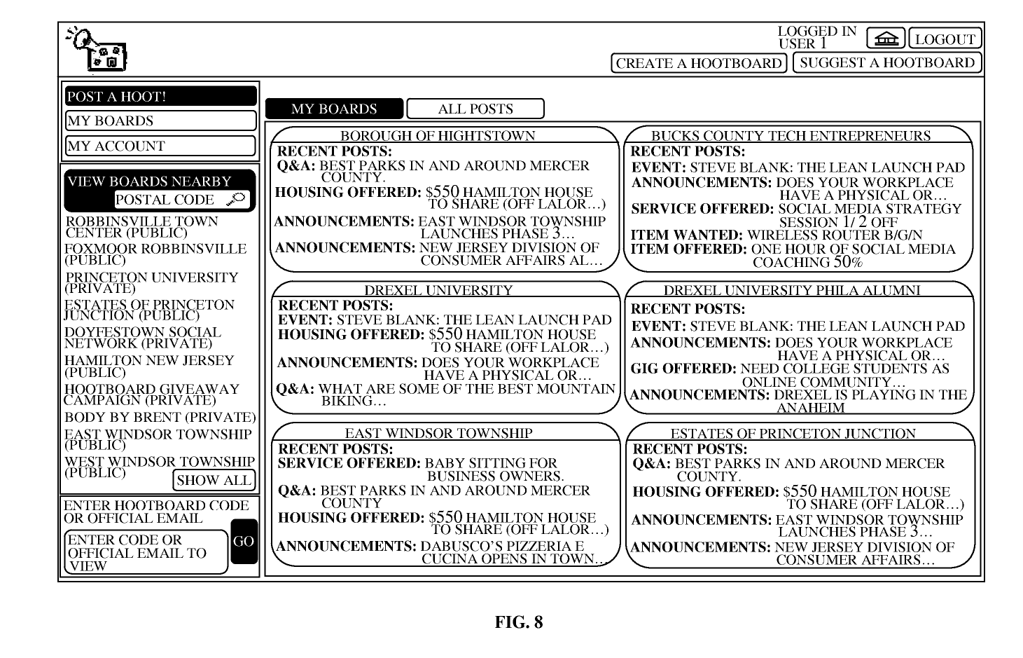

FIG. 8 exemplarily illustrates a screenshot of a graphical user interface (GUI) 507 provided by the electronic community board management platform 505 exemplarily illustrated in FIG. 5. The GUI 507 of the electronic community board management platform 505 displays a unique collective electronic community board comprising multiple electronic community boards of which the user 501 is a member. Each of the electronic community boards is represented by a box that outlines various electronic community board interactive electronic posts. The electronic community board management platform 505, also referred herein as a “hootboard”, enables users 501 to engage with multiple private electronic community boards and public electronic community boards for different communities via a single interface to list services via interactive electronic posts. The electronic community board management platform 505 enables users 501 to maintain a trust level with each community board, and promote listings on multiple community boards, thereby gaining a wider market reach. The electronic community board management platform 505 also provides potential advertisers with a segmented set of target groups which can be leveraged for highly targeted interactive electronic posts or advertorials.

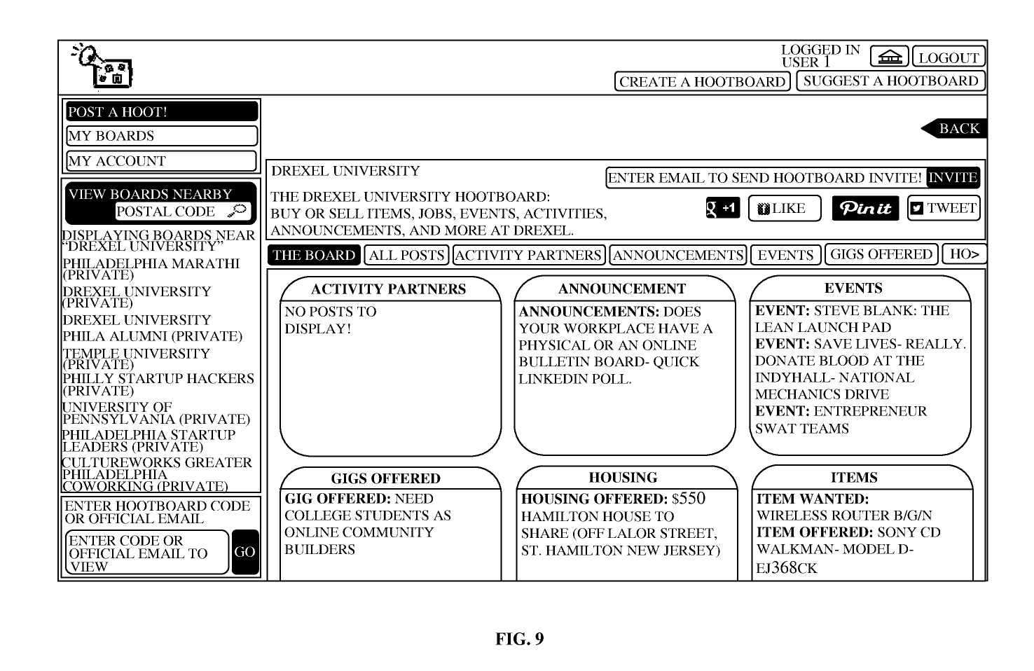

FIG. 9 exemplarily illustrates a screenshot of an electronic community board associated with a community, for example, a university. The community specific electronic community board shows various multimedia posting types displayed separately, and displays each of the interactive electronic posts via a link. The electronic community board facilitates access to the interactive electronic posts, announcements, events, etc., via multiple tabs or buttons as exemplarily illustrated in FIG. 9. The electronic community board management platform 505 also provides an option to view electronic community boards near the university by performing a search using the postcode of the location of the university.

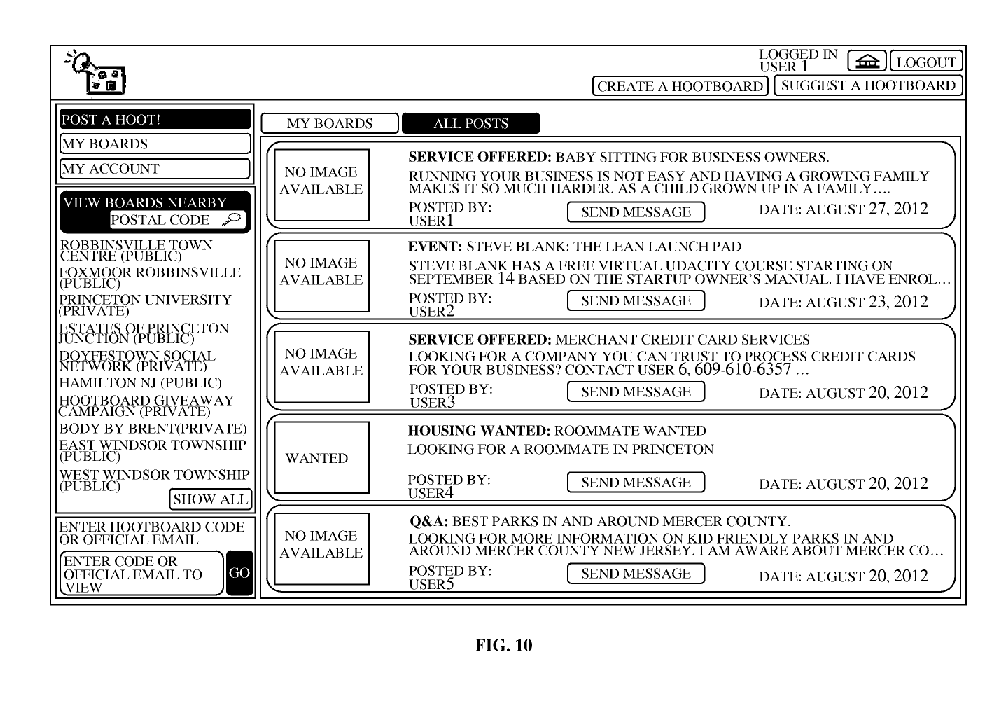

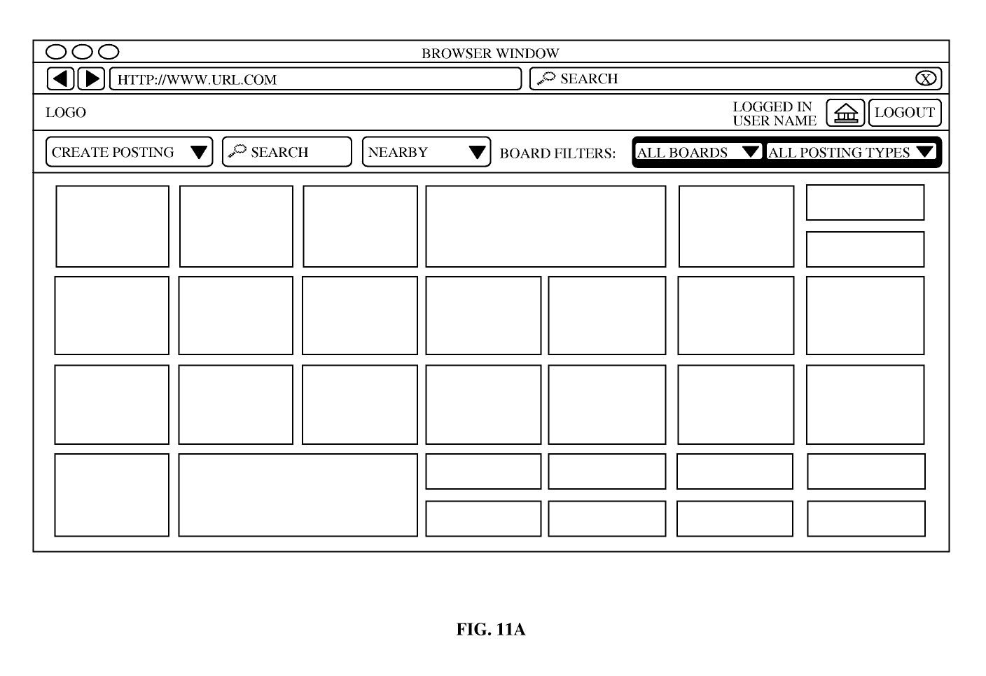

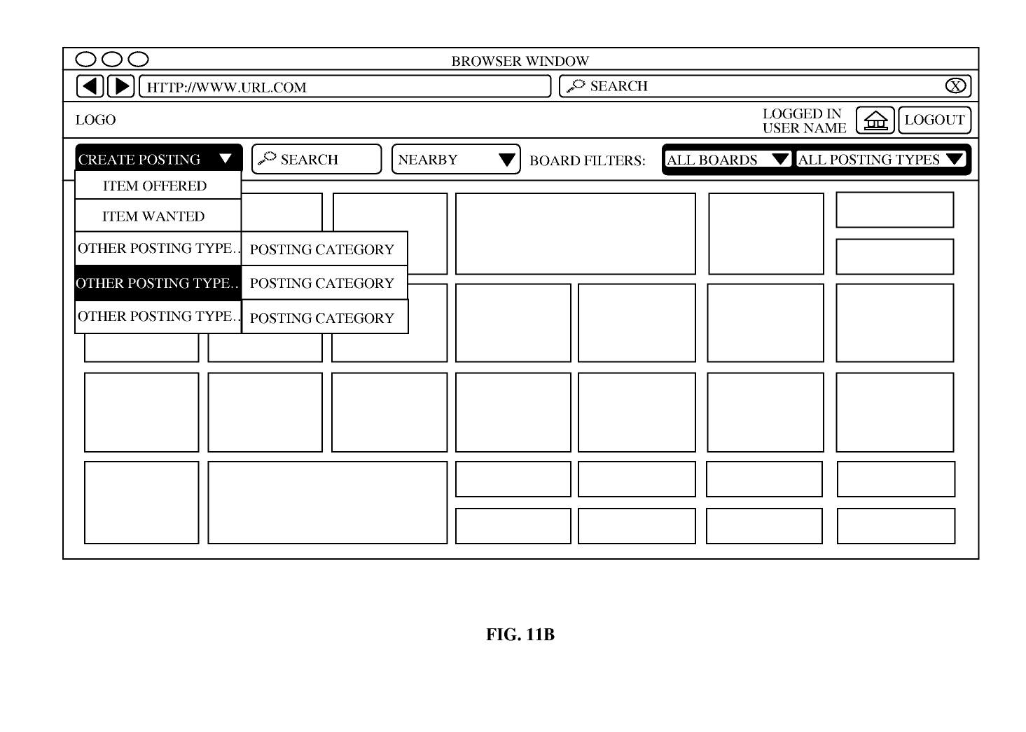

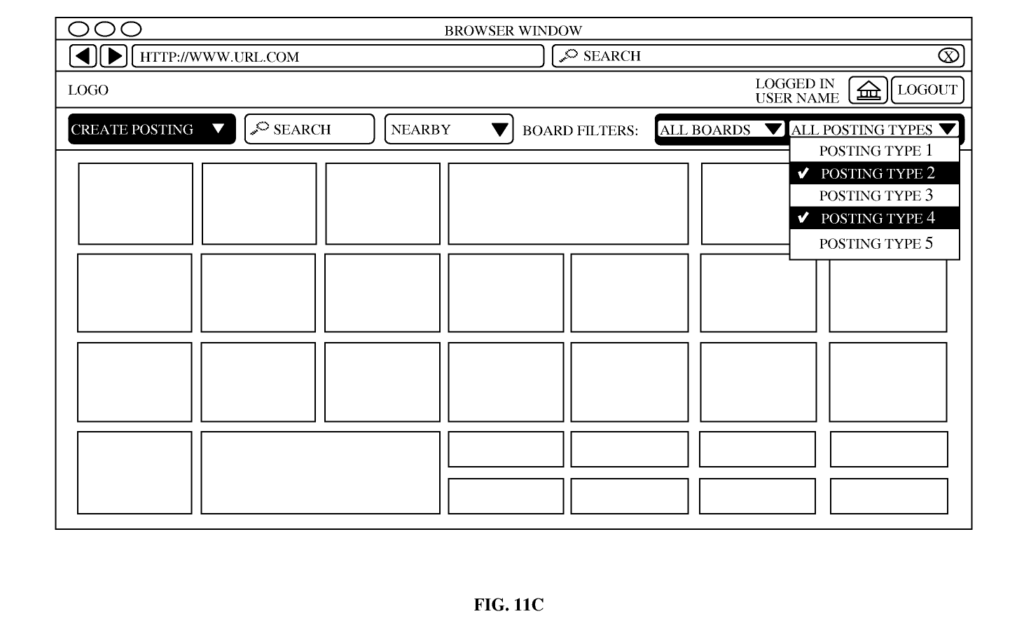

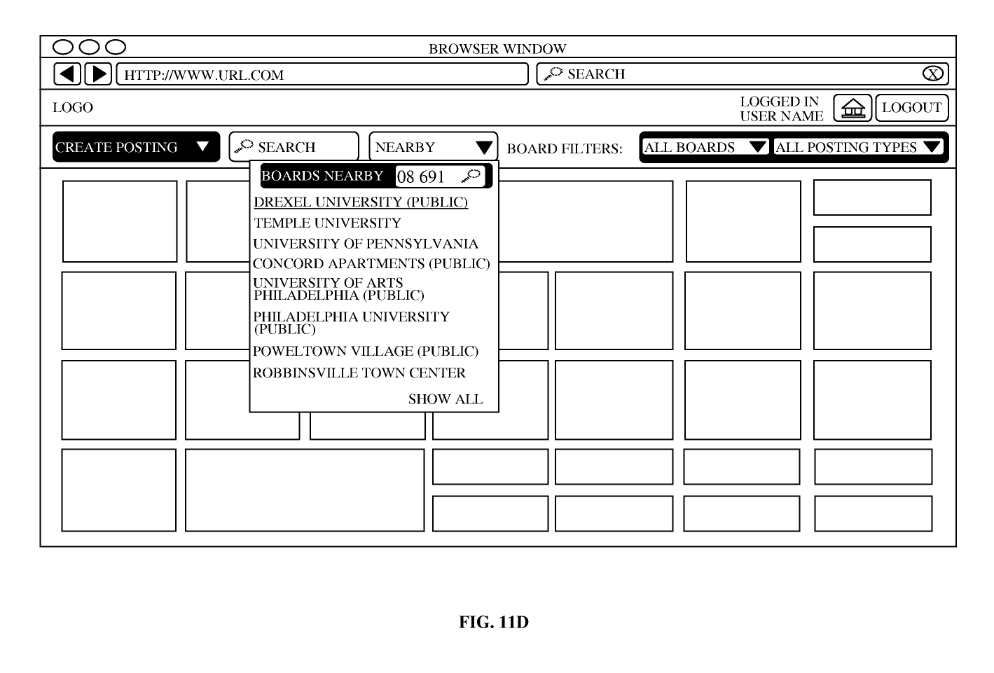

FIG. 10 exemplarily illustrates a screenshot of a graphical user interface (GUI) 507 provided by the electronic community board management platform 505, exemplarily illustrated in FIG. 5, displaying interactive electronic posts across different electronic community boards simultaneously. The electronic community board management platform 505 displays interactive electronic posts across different electronic community boards of which the user 501 is a member. The electronic community board management platform 505 displays the interactive electronic posts sequentially as exemplarily illustrated in FIG. 10. In an embodiment, the electronic community board management platform 505 displays the interactive electronic posts in a graphical format as exemplarily illustrated in FIGS. 11A-11D.

FIG. 11A exemplarily illustrates a screenshot of a graphical user interface (GUI) 507 provided by the electronic community board management platform 505, exemplarily illustrated in FIG. 5, showing an electronic community board in a graphical format with multiple community board filters. FIG. 11A provides a browser based view of an account of the user 501 where the user 501 sees all interactive electronic posts available to him/her in a graphical format. The electronic community board management platform 505 recreates a bulletin board approach with the interactive electronic posts visible in a format displayed on a bulletin board. In the browser-based view, the user 501 can view a custom electronic community board where interactive electronic posts made to multiple electronic community boards are made available to the user 501 for display. The user 501 can filter the browser-based view by electronic community boards, posting types, or a combination of both.

FIG. 11B exemplarily illustrates a screenshot of a graphical user interface (GUI) 507 provided by the electronic community board management platform 505, exemplarily illustrated in FIG. 5, showing options for creating an interactive electronic post on a graphics based electronic community board. FIG. 11B shows the graphics based electronic community board on which the user 501 may initiate creation of an interactive electronic post by selecting a specific posting type and a category to organize the interactive electronic post.

FIG. 11C exemplarily illustrates a screenshot of a graphical user interface (GUI) 507 provided by the electronic community board management platform 505, exemplarily illustrated in FIG. 5, showing multiple multimedia posting types for viewing interactive electronic posts. FIG. 11C shows how a user 501 can select multiple posting types to view interactive electronic posts based on the selected filter criteria.

FIG. 11D exemplarily illustrates a screenshot of a graphical user interface (GUI) 507 provided by the electronic community board management platform 505, exemplarily illustrated in FIG. 5, showing location or proximity based electronic community boards. In an embodiment, the electronic community board management platform 505 displays the electronic community boards geographically proximal to the user 501 on the GUI 507. The electronic community board management platform 505 allows the user 501 to join electronic community boards that are geographically proximal to the user 501.

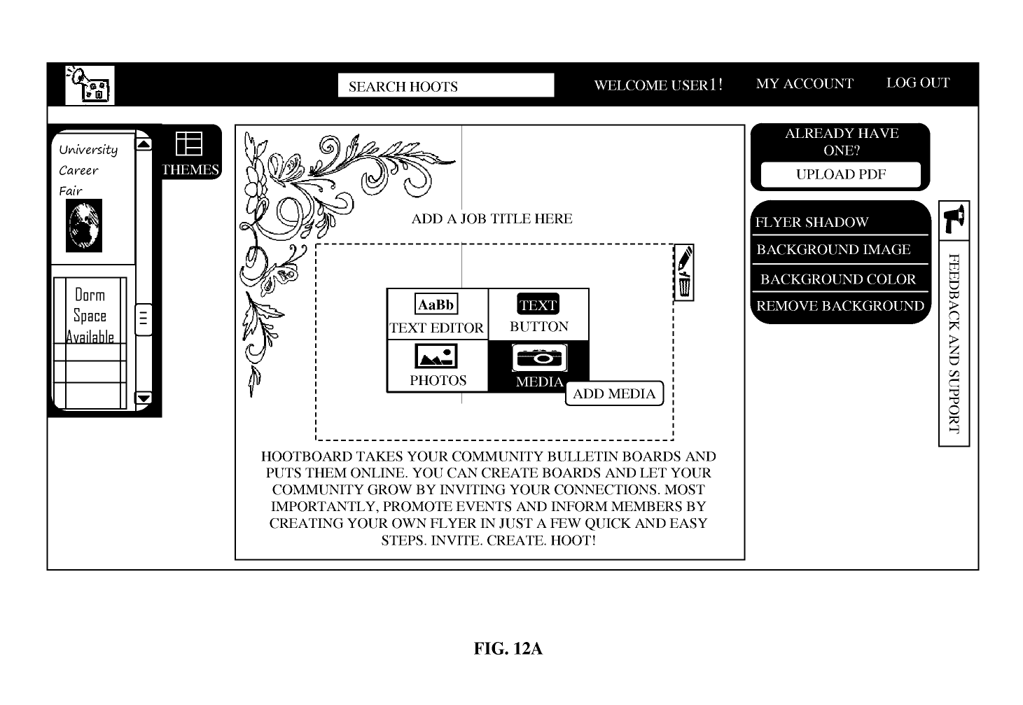

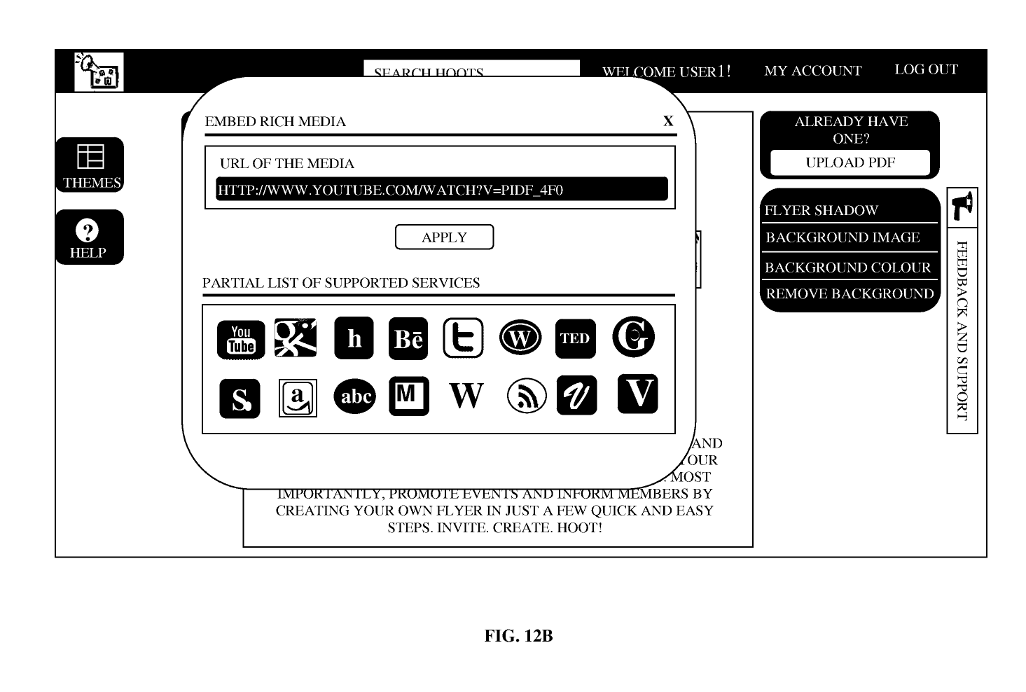

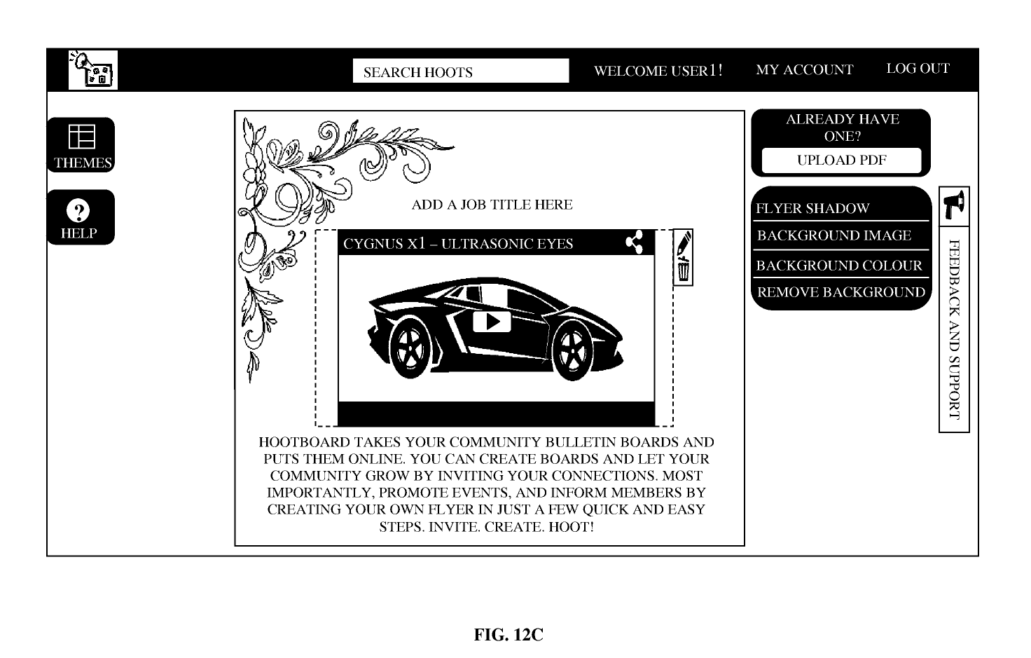

FIGS. 12A-12C exemplarily illustrate screenshots of a graphical user interface (GUI) 507 provided by the electronic community board management platform 505, exemplarily illustrated in FIG. 5, for creating an interactive electronic post. The electronic community board management platform 505 allows a user 501 to create customized interactive electronic posts. In an embodiment, the electronic community board management platform 505 allows a user 501 to upload other electronic posts in multiple formats, for example, a portable document format (PDF) from one or more of multiple sources for creating postings and sharing the uploaded other electronic posts on the created electronic community boards. The user 501 can create electronic posts using the uploaded electronic posts. In another embodiment, the electronic community board management platform 505 allows the user 501 to upload electronic posts created using third party services, for example, postlets.com, vflyer.com, etc., which are posted automatically through an application programming interface (API).

The electronic community board management platform 505 allows a user 501 to select the type of the electronic post and then upload an existing electronic post. The electronic community board management platform 505 displays multiple themes and layout options, for example, a flyer shadow, a background image, a background color, etc., on the GUI 507 as exemplarily illustrated in FIG. 12A. The user 501 can choose or select a theme and one or more layout options to customize the interactive electronic post. The electronic community board management platform 505 receives a selection of the displayed themes and layout options from the user 501 via the GUI 507 for creating the interactive electronic post. The electronic community board management platform 505 also provides an option to the user 501 to add media content from the electronic device 502 via the GUI 507 for the creation of the interactive electronic post. For example, the user 501 can upload a video via the electronic device 502 using an upload video option as exemplarily illustrated in FIGS. 12B-12C. The electronic community board management platform 505 then creates the interactive electronic post based on the selection of the displayed themes, layout options, and the selected media content.

FIGS. 13A-13C exemplarily illustrate screenshots of a graphical user interface (GUI) 507 provided by the electronic community board management platform 505, exemplarily illustrated in FIG. 5, for adjusting characteristics of an interactive electronic post. As exemplarily illustrated in FIGS. 13A-13B, the electronic community board management platform 505 provides post enhancing options for adjusting a size of each of the created interactive electronic posts, for example, prior to sharing the created interactive electronic posts on the created electronic community boards or after uploading other electronic posts on the created electronic community boards. A user 501 can change the size of an interactive electronic post using the post enhancing options. The electronic community board management platform 505 automatically calculates a cost associated with the adjustment of the characteristics of each of the created interactive electronic posts and executes a payment transaction based on the calculated cost. For example, the electronic community board management platform 505 automatically calculates a payment value or cost based on the size of the created interactive electronic post or the other electronic post and displays the charges or costs associated with each size adjustment as exemplarily illustrated in FIG. 13B. The electronic community board management platform 505 charges the user 501 based on the calculated cost. The electronic community board management platform 505 can accept inputs from an electronic device 502 having a card reader via the network 503 to accept electronic payments from the user 501. The electronic community board management platform 505 also allows the user 501 to click on the interactive electronic post displayed on the created electronic community board to zoom in or increase the size of the interactive electronic post as exemplarily illustrated in FIGS. 13A-13B. The user 501 obtains larger visibility of the interactive electronic post by changing the size of the interactive electronic post to be displayed on the created electronic community board while uploading other electronic posts or media content. A larger interactive electronic post is more visible when compared to the other interactive electronic posts as exemplarily illustrated in FIG. 13C.

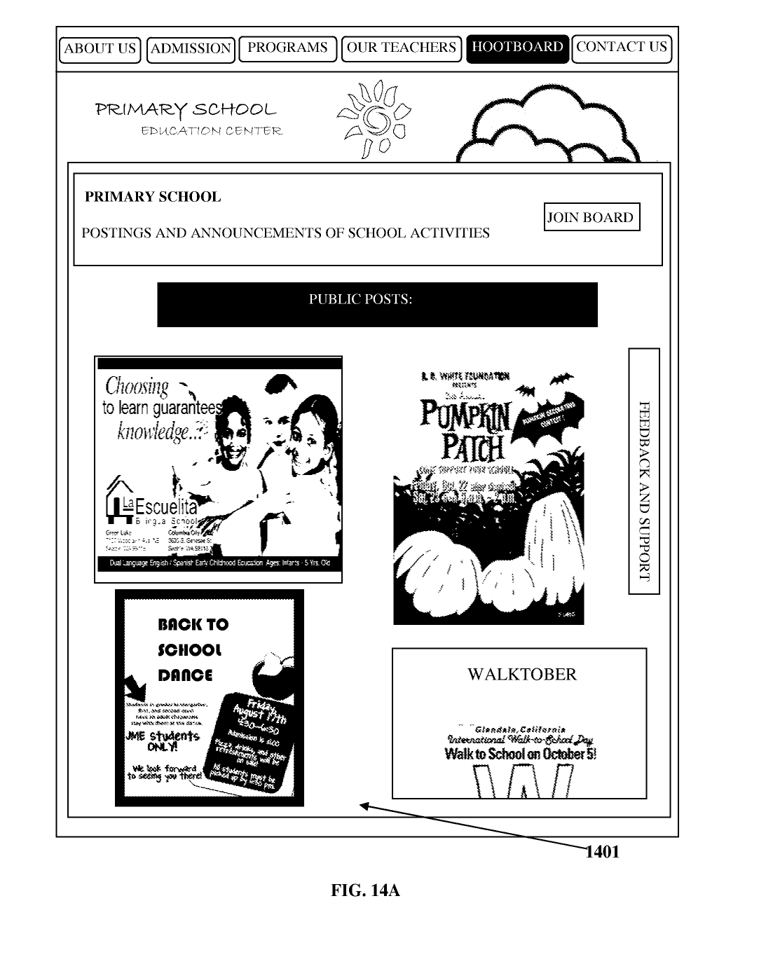

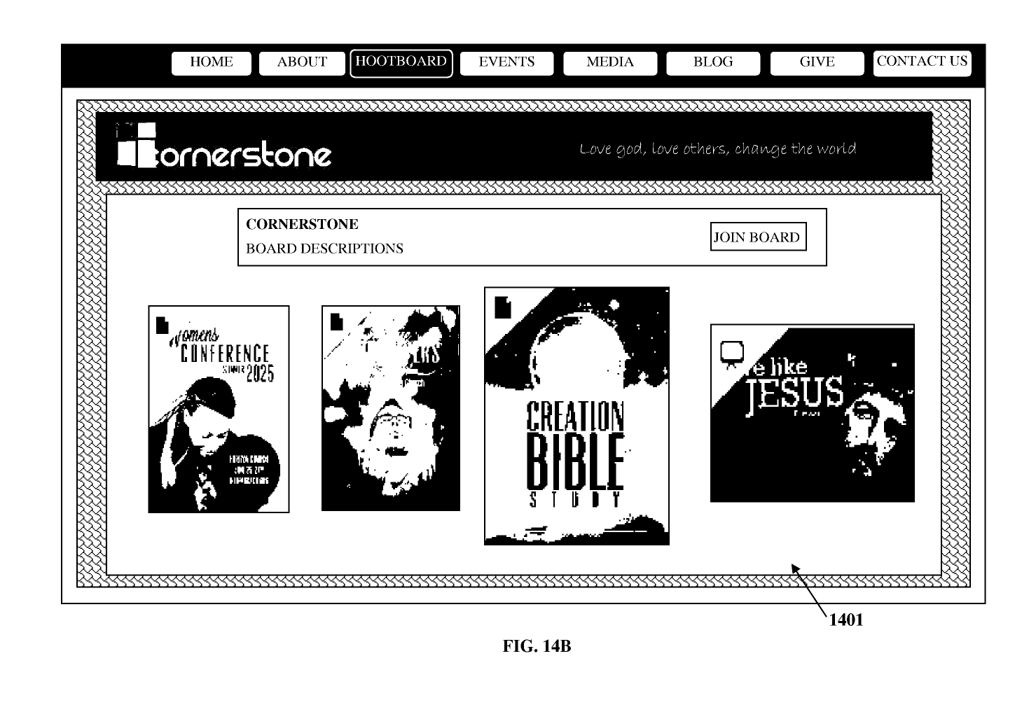

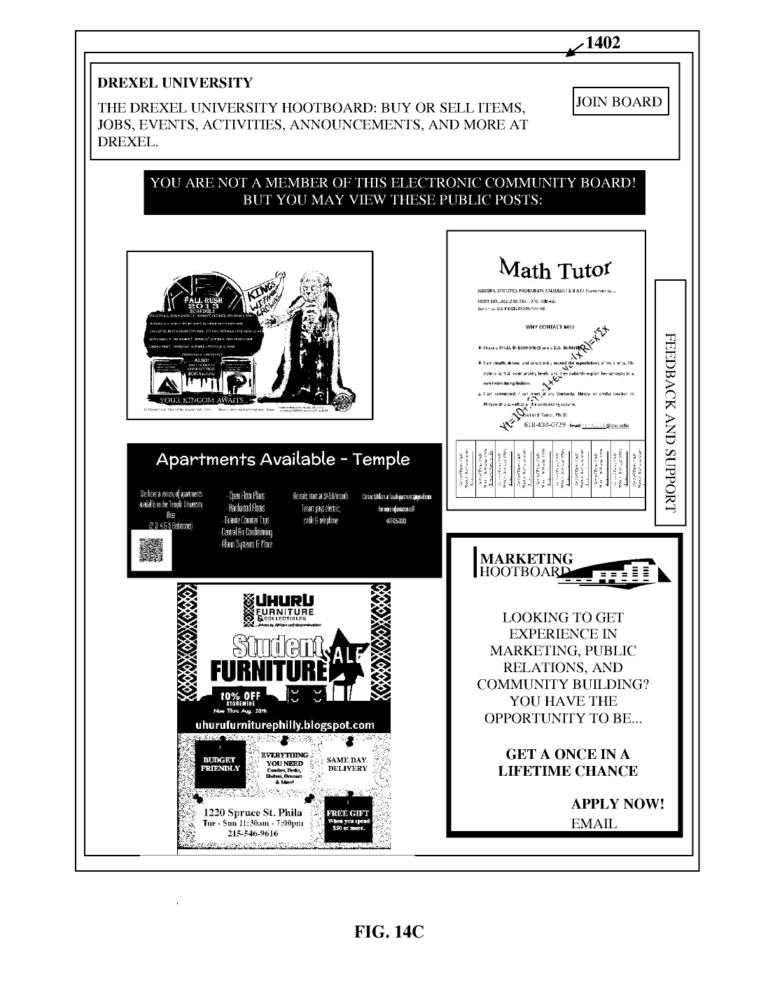

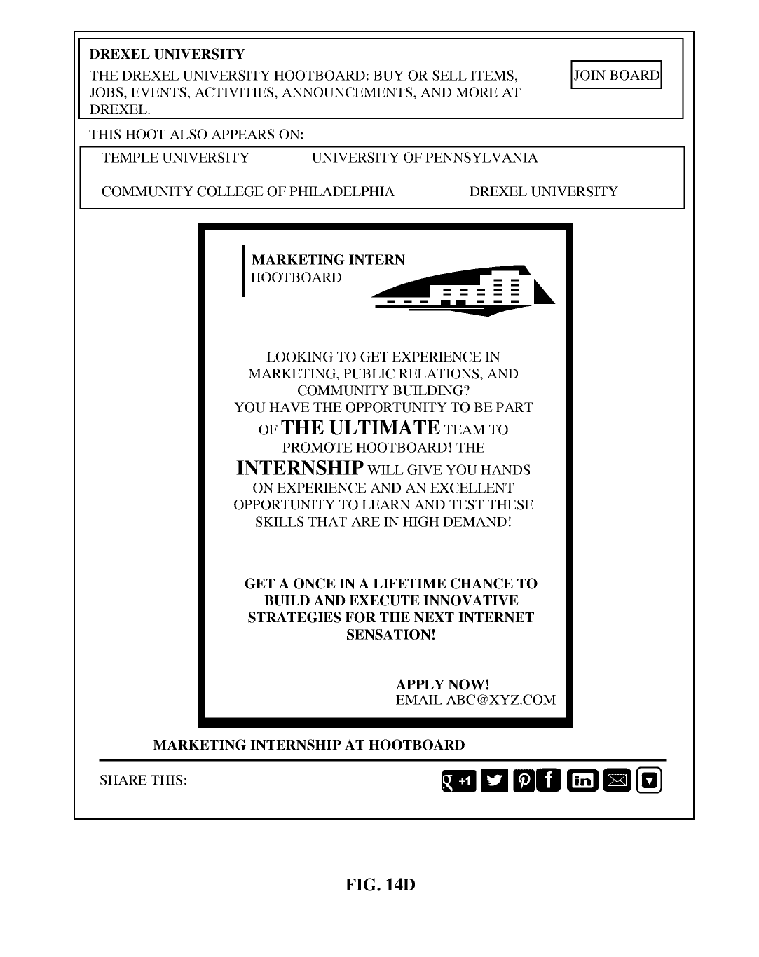

FIGS. 14A-14D exemplarily illustrate screenshots of electronic community boards 1401 and 1402 embedded in a website hosted by a community. In an embodiment, the electronic community board management platform 505 embeds the created electronic community board, for example, 1401 or 1402 or the created interactive electronic post or the uploaded electronic post in any webpage or website hosted by one or more communities. For example, the electronic community board management platform 505 embeds an electronic community board 1401 on a school website as exemplarily illustrated in FIG. 14A. In another example, the electronic community board management platform 505 embeds an electronic community board 1401 on a church website as exemplarily illustrated in FIG. 14B. The created electronic community board, for example, 1401 or 1402, also referred to as a bulletin board, is embedded from the parent website or the main website into official websites hosted by different communities. A user 501 has to join the electronic community boards 1401 and 1402 displayed on these websites to access electronic posts that are not public. In another example, the electronic community board management platform 505 embeds a university board 1402 in a webpage of another community website as exemplarily illustrated in FIG. 14C. The electronic community board management platform 505 also embeds the created interactive electronic posts or the uploaded electronic posts on other websites or channels, for example, Craigslist® of Craigslist, Inc. For example, the electronic community board management platform 505 embeds an electronic post advertising a marketing intern opening into a university website as exemplarily illustrated in FIG. 14C. When a user 501 clicks on the interactive electronic post through the website, the electronic community post management platform 505 displays an enlarged view of the interactive electronic post and also displays other information related to the interactive electronic post, for example, the other university websites on which the interactive electronic post is displayed as exemplarily illustrated in FIG. 14D.

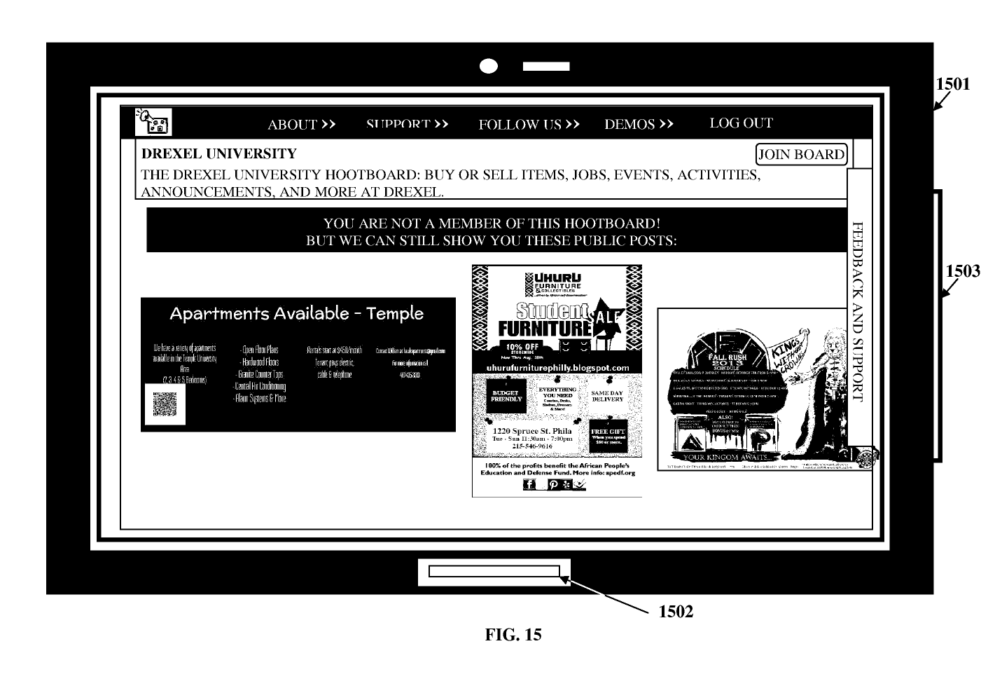

FIG. 15 exemplarily illustrates display of an electronic community board on an electronic device, for example, a networked display board 1501 that communicates with the electronic community board management platform 505 in a community environment. In an example, the electronic community board management platform 505 can be accessed by networked display boards 1501 mounted in the geographical area or in lobbies of buildings and other public places in a university. The users 501 can interact with an electronic community board on the electronic community board management platform 505 through the networked display boards 1501. In an embodiment, the user 501 can browse the electronic community boards by using a wave motion input sensed by a motion sensor 1502 on the networked display board 1501. The electronic community board management platform 505 displays public electronic posts to users 501 who are not members of the electronic community boards. The electronic community board management platform 505 allows users 501 to join one or more electronic community boards based on the preference of the users 501. In an example, if a particular electronic community board provides paid subscriptions, the user 501 has the option to pay using a credit card or a debit card by using a card reader 1503 provided on the networked display board 1501. The electronic community board management platform 505 automatically accepts payments made via the card reader 1503. The electronic community board management platform 505 then displays the selected electronic community boards and the interactive electronic posts associated with the selected electronic community boards for viewing by the user 501. The user 501 may also use the card reader 1503 provided on the networked display board 1501 to pay for adjustments made to the characteristics of the interactive electronic posts based on the cost calculated by the electronic community board management platform 505.

Consider an example of a student who is a member of two communities, that is, a university and a sports group. The student is a member of a sports committee of the university which is hosting a sporting event and he wants to promote the sporting event via the electronic community board management platform 505. The student logs into the electronic community board management platform 505 by providing his user information via the GUI 507. The student then provides information about the two communities with which he is associated via the GUI 507. The electronic community board management platform 505 creates electronic community boards associated with the university and the sports group or embeds electronic community boards on the university website. The electronic community board management platform 505 also generates a unique collective electronic community board using the created electronic community boards so that the student can view information of both the communities in one place. The student can view all the interactive electronic posts related to both the communities via the generated unique collective electronic community board.

The student then navigates to an electronic post creation section on the GUI 507 of the electronic community board management platform 505 and chooses a theme and a layout for creating an interactive electronic post. The student also enters the details of the sporting event and uploads a few pictures featuring different types of sports competitions which are to be held during the sporting event. The electronic community board management platform 505 creates an interactive electronic post based on the user inputs received from the student and provides multiple post enhancing options for displaying the created interactive electronic post to the student. The student adjusts the size of the created interactive electronic post and makes the necessary payments, for example, by swiping a credit card on his user device 502. The electronic community board management platform 505 accepts the payment information and executes the payment transaction. The electronic community board management platform 505 then displays multiple sharing options for sharing the created interactive electronic post. The student can choose to display the created interactive electronic post on the electronic community boards of both the communities and also share the created interactive electronic post, for example, via Facebook®, or email the created interactive electronic post to his contacts. The electronic community board management platform 505 posts the created interactive electronic post on the student's Facebook® profile and also displays the created interactive electronic post on the electronic community boards of the student's communities. The electronic community board management platform 505 also embeds the created interactive electronic post on the university's website.

It will be readily apparent that the various methods, algorithms, and computer programs disclosed herein may be implemented on computer readable media appropriately programmed for computing devices. As used herein, the term “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc®, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of programming languages that can be used comprise C, C++, C#, Java®, JavaScript®, Fortran, Ruby, Pascal, Perl®, Python®, Visual Basic®, hypertext preprocessor (PHP), hypertext markup language (HTML), Cascading Style Sheets® (CSS), JavaScript® Object Notation (JSON), Java Server Pages® (JSP), etc. Other object-oriented, functional, scripting, and/or logical programming languages may also be used. The computer program codes or software programs may be stored on or in one or more mediums as object code. Various aspects of the method and system disclosed herein may be implemented as programmed elements, or non-programmed elements, or any suitable combination thereof. The computer program product disclosed herein comprises computer executable instructions embodied in a non-transitory computer readable storage medium, wherein the computer program product comprises one or more computer program codes for implementing the processes of various embodiments.

Where databases are described such as the database 516, it will be understood by one of ordinary skill in the art that (i) alternative database structures to those described may be readily employed, and (ii) other memory structures, for example, cache stores besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices may comprise processors, for example, the Intel® processors, Advanced Micro Devices (AMD®) processors, UltraSPARC® processors, Hp® processors, International Business Machines (IBM®) processors, RISC based computer processors of ARM Holdings, Motorola® processors, etc., that are adapted to communicate with the computers. In an embodiment, each of the computers is equipped with a network communication device, for example, a network interface card, a modem, or other network connection device suitable for connecting to a network. Each of the computers and the devices executes an operating system, for example, the Linux® operating system, the Unix® operating system, any version of the Microsoft® Windows® operating system, the Mac OS of Apple Inc., the IBM® OS/2, the Palm OS®, the Android® OS, the Blackberry® OS, the Solaris operating system developed by Sun Microsystems, Inc., or any other operating system. Handheld devices execute operating systems, for example, the Android operating system, the Windows Phone® operating system of Microsoft Corporation, the BlackBerry® operating system of Research in Motion Limited, the iOS operating system of Apple Inc., the Symbian® operating system of Symbian Foundation Limited, etc. While the operating system may differ depending on the type of computer, the operating system will continue to provide the appropriate communications protocols to establish communication links with the network. Any number and type of machines may be in communication with the computers.

The present invention is not limited to a particular computer system platform, processor, operating system, or network. One or more aspects of the present invention may be distributed among one or more computer systems, for example, servers configured to provide one or more services to one or more client computers, or to perform a complete task in a distributed system. For example, one or more aspects of the present invention may be performed on a client-server system that comprises components distributed among one or more server systems that perform multiple functions according to various embodiments. These components comprise, for example, executable, intermediate, or interpreted code, which communicate over a network using a communication protocol. The present invention is not limited to be executable on any particular system or group of systems, and is not limited to any particular distributed architecture, network, or communication protocol.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A computer implemented method for simultaneously engaging a plurality of electronic community boards associated with a plurality of communities, comprising:
providing an electronic community board management platform comprising at least one processor configured to enable said simultaneous engagement of said electronic community boards associated with said communities;
receiving user information and board information via a graphical user interface provided by said electronic community board management platform;
creating one or more electronic community boards associated with one or more of said communities by said electronic community board management platform using said received user information and said board information;
generating a unique collective electronic community board for a user associated with said one or more of said communities by said electronic community board management platform using said created one or more electronic community boards;
creating one or more interactive electronic posts in one or more media formats by said electronic community board management platform based on media inputs received from an electronic device;
selectively displaying said created one or more interactive electronic posts on said created one or more electronic community boards by said electronic community board management platform based on display criteria; and
managing actions triggered by user inputs received from said electronic device on said generated unique collective electronic community board by said electronic community board management platform.

2. The computer implemented method of claim 1, wherein said media inputs for creating said one or more interactive electronic posts comprise one or more of themes, layouts, and media content, wherein said media content comprises one or more of textual content, image content, audio content, video content, audiovisual content, multimedia content, digital content, widgets, web objects, and any combination thereof.

3. The computer implemented method of claim 1, wherein said display criteria for selectively displaying said created one or more interactive electronic posts on said created one or more electronic community boards comprise one or more of community type, privacy settings, user preferences, content of said created one or more interactive electronic posts, type of said created one or more electronic community boards, a location of said user associated with said one or more of said communities, a location of each of said communities, a location defined in each of said created one or more interactive electronic posts, and a location of said electronic device configured to display said created one or more electronic community boards and said created one or more interactive electronic posts.

4. The computer implemented method of claim 1, further comprising transmitting electronic invitations to one or more users by said electronic community board management platform via a network for enabling one of said creation of said one or more electronic community boards and joining one or more of said created one or more electronic community boards.

5. The computer implemented method of claim 1, further comprising displaying said generated unique collective electronic community board and said created one or more interactive electronic posts on a plurality of electronic devices by said electronic community board management platform, wherein said electronic community board management platform is configured to receive said user inputs and gestures of a plurality of different types from said electronic devices.

6. The computer implemented method of claim 1, further comprising providing post enhancing options by said electronic community board management platform for adjusting characteristics of each of said created one or more interactive electronic posts.

7. The computer implemented method of claim 6, further comprising automatically calculating a cost associated with said adjustment of said characteristics of said each of said created one or more interactive electronic posts by said electronic community board management platform and executing a payment transaction based on said calculated cost.

8. The computer implemented method of claim 1, further comprising uploading external electronic posts in a plurality of formats from one or more of a plurality of sources by said electronic community board management platform and selectively displaying said uploaded external electronic posts on said created one or more electronic community boards.

9. The computer implemented method of claim 1, further comprising sharing said created one or more interactive electronic posts with one or more users associated with said one or more of said communities by said electronic community board management platform based on sharing options provided by said electronic community board management platform.

10. The computer implemented method of claim 9, wherein said sharing options comprise one or more of privately sharing said created one or more interactive electronic posts on said created one or more electronic community boards, sharing said created one or more interactive electronic posts via electronic mail, and posting said created one or more interactive electronic posts on one or more social networking platforms.

11. The computer implemented method of claim 1, further comprising providing one or more incentives to said user by said electronic community board management platform based on a number of said created one or more interactive electronic posts shared by said user and a number of said created one or more electronic community boards engaged by said user.

12. The computer implemented method of claim 1, further comprising embedding said created one or more electronic community boards on one or more websites hosted by one or more of said communities, by said electronic community board management platform.

13. The computer implemented method of claim 1, further comprising integrating a plurality of document editors within said electronic community board management platform, wherein said electronic community board management platform is configured to receive one or more electronic posts from said integrated document editors and share said received one or more electronic posts on said created one or more electronic community boards.

14. The computer implemented method of claim 1, further comprising targeting said created one or more interactive electronic posts to said one or more of said communities by said electronic community board management platform based on targeting criteria, wherein said targeting criteria comprise a location of each of said one or more of said communities, a location defined in each of said created one or more interactive electronic posts, and a location of said user associated with said one or more of said communities.

15. The computer implemented method of claim 1, further comprising controlling access to said created one or more electronic community boards by said electronic community board management platform based on said received board information.

16. The computer implemented method of claim 1, further comprising generating and transmitting notifications associated with said actions triggered by said user inputs received from said electronic device on said generated unique collective electronic community board, by said electronic community board management platform.

17. The computer implemented method of claim 1, further comprising categorizing and managing said created one or more interactive electronic posts on said created one or more electronic community boards by said electronic community board management platform.

18. The computer implemented method of claim 1, further comprising filtering said created one or more interactive electronic posts displayed on said created one or more electronic community boards by said electronic community board management platform based on filter criteria.

19. The computer implemented method of claim 1, further comprising requesting approval from said user by said electronic community board management platform for simultaneously displaying said created one or more interactive electronic posts on said created one or more electronic community boards.

20. The computer implemented method of claim 1, further comprising providing a search engine by said electronic community board management platform, wherein said search engine is configured to allow said user to search for said created one or more electronic community boards and said created one or more interactive electronic posts on said created one or more electronic community boards simultaneously based on search criteria, wherein said search criteria comprise one or more of a location of each of said one or more of said communities, a location defined in each of said created one or more interactive electronic posts, and a location of said electronic device configured to display said created one or more electronic community boards and said created one or more interactive electronic posts.

21. The computer implemented method of claim 1, further comprising integrating a plurality of social networking platforms within said electronic community board management platform via said network for facilitating said creation of said one or more electronic community boards and said creation of said one or more interactive electronic posts, and sharing of said created one or more interactive electronic posts via a network.

22. A computer implemented system for simultaneously engaging a plurality of electronic community boards associated with a plurality of communities, comprising:
an electronic community board management platform comprising:
at least one processor configured to execute modules of said electronic community board management platform;
a non-transitory computer readable storage medium communicatively coupled to said at least one processor, said non-transitory computer readable storage medium configured to store said modules of said electronic community board management platform; and
said modules of said electronic community board management platform, comprising:
a data reception module configured to receive user information and board information via a graphical user interface provided by said electronic community board management platform;
a board creation module configured to create one or more electronic community boards associated with one or more of said communities using said received user information and said board information;
said board creation module further configured to generate a unique collective electronic community board for a user associated with said one or more of said communities using said created one or more electronic community boards;
an electronic post creation and management module configured to create one or more interactive electronic posts in one or more media formats based on media inputs received from an electronic device;
said electronic post creation and management module further configured to selectively display said created one or more interactive electronic posts on said created one or more electronic community boards based on display criteria; and
an action management module configured to manage actions triggered by user inputs received from said electronic device on said generated unique collective electronic community board.

23. The computer implemented system of claim 22, wherein said media inputs for creating said one or more interactive electronic posts comprise one or more of themes, layouts, and media content, wherein said media content comprises one or more of textual content, image content, audio content, video content, audiovisual content, multimedia content, digital content, widgets, web objects, and any combination thereof.

24. The computer implemented system of claim 22, wherein said display criteria for selectively displaying said created one or more interactive electronic posts on said created one or more electronic community boards comprise one or more of community type, privacy settings, user preferences, content of said created one or more interactive electronic posts, type of said created one or more electronic community boards, a location of said user associated with said one or more of said communities, a location of each of said communities, a location defined in each of said created one or more interactive electronic posts, and a location of said electronic device configured to display said created one or more electronic community boards and said created one or more interactive electronic posts.

25. The computer implemented system of claim 22, wherein said action management module is further configured to perform one or more of:
transmitting electronic invitations to one or more users via a network for enabling one of said creation of said one or more electronic community boards and joining one or more of said created one or more electronic community boards; and
generating and transmitting notifications associated with said actions triggered by said user inputs received from said electronic device on said generated unique collective electronic community board.

26. The computer implemented system of claim 22, wherein said board creation module is further configured to display said generated unique collective electronic community board and said created one or more interactive electronic posts on a plurality of electronic devices, wherein said data reception module is configured to receive said user inputs and gestures of a plurality of different types from said electronic devices.

27. The computer implemented system of claim 22, wherein said electronic post creation and management module is further configured to provide post enhancing options for adjusting characteristics of each of said created one or more interactive electronic posts, and wherein said electronic post creation and management module is further configured to automatically calculate a cost associated with said adjustment of said characteristics of said each of said created one or more interactive electronic posts and execute a payment transaction based on said calculated cost.

28. The computer implemented system of claim 22, wherein said electronic post creation and management module is further configured to upload external electronic posts in a plurality of formats from one or more of a plurality of sources and integrated document editors and selectively display said uploaded external electronic posts on said created one or more electronic community boards.

29. The computer implemented system of claim 22, wherein said electronic post creation and management module is further configured to share said created one or more interactive electronic posts with one or more users associated with said one or more of said communities based on sharing options provided by said electronic community board management platform, wherein said sharing options comprise one or more of privately sharing said created one or more interactive electronic posts on said created one or more electronic community boards, sharing said created one or more interactive electronic posts via electronic mail, and posting said created one or more interactive electronic posts on one or more social networking platforms.

30. The computer implemented system of claim 22, wherein said board creation module is further configured to perform one or more of:
controlling access to said created one or more electronic community boards based on said received board information; and
embedding said created one or more electronic community boards on one or more websites hosted by one or more of said communities.

31. The computer implemented system of claim 22, wherein said electronic post creation and management module is further configured to perform one or more of:
categorizing and managing said created one or more interactive electronic posts on said created one or more electronic community boards;
filtering said created one or more interactive electronic posts displayed on said created one or more electronic community boards based on filter criteria;
requesting approval from said user for simultaneously displaying said created one or more interactive electronic posts on said created one or more electronic community boards; and
targeting said created one or more interactive electronic posts to said one or more of said communities based on targeting criteria, wherein said targeting criteria comprise a location of each of said one or more of said communities, a location defined in each of said created one or more interactive electronic posts, and a location of said user associated with said one or more of said communities.

32. The computer implemented system of claim 22, wherein said modules of said electronic community board management platform further comprise a search engine configured to allow said user to search for said created one or more electronic community boards and said created one or more interactive electronic posts on said created one or more electronic community boards simultaneously based on search criteria, wherein said search criteria comprise one or more of a location of each of said one or more of said communities, a location defined in each of said created one or more interactive electronic posts, and a location of said electronic device configured to display said created one or more electronic community boards and said created one or more interactive electronic posts.

33. A computer program product comprising a non-transitory computer readable storage medium, said non-transitory computer readable storage medium storing computer program codes that comprise instructions executable by at least one processor, said computer program codes comprising:
a first computer program code for receiving user information and board information via a graphical user interface;
a second computer program code for creating one or more electronic community boards associated with one or more of a plurality of communities using said received user information and said board information;
a third computer program code for generating a unique collective electronic community board for a user associated with said one or more of said communities using said created one or more electronic community boards;
a fourth computer program code for creating one or more interactive electronic posts in one or more media formats based on media inputs received from an electronic device;
a fifth computer program code for selectively displaying said created one or more interactive electronic posts on said created one or more electronic community boards based on display criteria, wherein said display criteria comprise one or more of community type, privacy settings, user preferences, content of said created one or more interactive electronic posts, and type of said created one or more electronic community boards, a location of said user associated with said one or more of said communities, a location of each of said communities, a location defined in each of said created one or more interactive electronic posts, and a location of said electronic device configured to display said created one or more electronic community boards and said created one or more interactive electronic posts; and
a sixth computer program code for managing actions triggered by user inputs received from said electronic device on said generated unique collective electronic community board.

34. The computer program product of claim 33, wherein said computer program codes further comprise:
a seventh computer program code for displaying said generated unique collective electronic community board and said created one or more interactive electronic posts on a plurality of electronic devices; and
an eighth computer program code for receiving said user inputs and gestures of a plurality of different types from said electronic devices.

35. The computer program product of claim 33, wherein said computer program codes further comprise a ninth computer program code for automatically calculating a cost associated with an adjustment of characteristics of said each of said created one or more interactive electronic posts and executing a payment transaction based on said calculated cost.
